(19) United States
(12) Patent Application Publication
(10) Pub. No.: US 2026/0093018 A1
(43) Pub. Date: Apr. 2, 2026

(54) PHOTODETECTION DEVICE AND RANGING SYSTEM

(71) Applicant: SONY SEMICONDUCTOR SOLUTIONS CORPORATION, KANAGAWA (JP)

(72) Inventors: AKITO SEKIYA, KANAGAWA (JP); MASAMUNE HAMAMATSU, KANAGAWA (JP); NORIAKI ENDO, KANAGAWA (JP); YOSHIYUKI SAITO, KANAGAWA (JP)

(21) Appl. No.: 19/113,136

(22) PCT Filed: Sep. 27, 2023
(86) PCT No.: PCT/JP2023/035078

§ 371 Date: Mar. 19, 2025

(30) Foreign Application Priority Data
Sep. 27, 2022 (JP) 2022-154157

(51) Int. Cl. G01S 7/4865; G01S 7/484; G01S 17/10; G01S 17/931

(52) U.S. Cl. CPC G01S 7/4865; G01S 7/484; G01S 17/10; G01S 17/931

(57) ABSTRACT

To improve ranging accuracy with a small number of times of light emission and light reception regardless of a distance of an object.
A photodetection device includes: a light receiving section that receives, within a first time range, a first reflected light pulse signal in which a first light pulse signal emitted at a first time interval is reflected by an object, and receives, within a second time range different from the first time range, a second reflected light pulse signal in which a second light pulse signal emitted at a second time interval different from the first time interval is reflected by the object; and a histogram generator that generates a first histogram in which a light reception frequency of the first reflected light pulse signal received within the first time range is classified for each predetermined fixed unit period, and generates a second histogram in which a light reception frequency of the second reflected light pulse signal received within the second time range is classified for each unit period.

### TECHNICAL FIELD

The present disclosure relates to a photodetection device and a ranging system.

### BACKGROUND ART

A ranging method called a time of flight (ToF) scheme that emits light from an object and measures a distance to the object on the basis of reflected light from the object is known. The ToF scheme includes a direct ToF (dToF) scheme of measuring a distance of an object on the basis of a time difference between a light emission timing and a light reception timing, and an indirect ToF (iToF) scheme of measuring a distance of an object on the basis of a shift between a light emission phase and a light reception phase. In any scheme, in order to improve the ranging accuracy, it is necessary to perform ranging a plurality of times by repeatedly emitting light and repeatedly receiving reflected light from an object.

However, in a case where the distance to the object is long, the light round-trip interval from when the light is emitted to when the reflected light is received may be longer than the light emission interval of the light. In this case, the ranging section may erroneously perform the ranging calculation on the light emission timing corresponding to the received reflected light, and the ranging accuracy decreases. In order to solve this problem, techniques have been proposed in which light beams having different light emission cycles are emitted, and reflected light beams thereof are overlaid to accurately perform ranging calculation (for example, Non-Patent Document 1).

### CITATION LIST

### Non-Patent Document

Non-Patent Document 1: Phase Unwrapping in Indirect Time of Flight|Chronoptics Time-of-Flight (https://medium.com/chronoptics-time-of-flight/phase-wrapping-and-its-solution-in-time-of-flight-depth-sensing-493aa8b21c42)

### SUMMARY OF THE INVENTION

### Problems to be Solved by the Invention

The contents disclosed in Non-Patent Document 1 are merely a conceptual description of the iToF scheme, and a specific system configuration is not disclosed. In particular, Non-Patent Document 1 does not disclose a specific system configuration in the dToF scheme. In light detection and ranging (LiDAR) and the like used in automated driving technology, the dToF scheme is often adopted, and thus a technology for improving distance accuracy in the dToF scheme with a small number of times of light emission and light reception is required.

Therefore, the present disclosure provides a photodetection device and a ranging system capable of improving ranging accuracy with a small number of times of light emission and light reception regardless of the distance of an object.

### Solutions to Problems

In order to solve the above problem, according to the present disclosure, there is provided a photodetection device including:
a light receiving section that receives, within a first time range, a first reflected light pulse signal in which a first light pulse signal emitted at a first time interval is reflected by an object, and receives, within a second time range different from the first time range, a second reflected light pulse signal in which a second light pulse signal emitted at a second time interval different from the first time interval is reflected by the object; and
a histogram generator that generates a first histogram in which a light reception frequency of the first reflected light pulse signal received within the first time range is classified for each predetermined fixed unit period, and generates a second histogram in which a light reception frequency of the second reflected light pulse signal received within the second time range is classified for each unit period.

The photodetection device may further include a duplicate histogram generator that generates a first duplicate histogram obtained by duplicating the first histogram by a first number corresponding to the first time interval and generates a second duplicate histogram obtained by duplicating the second histogram by a second number corresponding to the second time interval.

The light receiving section may receive, within two or more different time ranges, two or more reflected light pulse signals in which two or more light pulse signals emitted at two or more time intervals including the first time interval and the second time interval different from each other are reflected by the object,
the histogram generator may generate two or more histograms obtained by classifying light reception frequencies of the two or more reflected light pulse signals received within the two or more time ranges for each unit period,
the duplicate histogram generator may generate two or more duplicate histograms obtained by duplicating each of the two or more histograms by a number corresponding to the time intervals corresponding,
the two or more histograms generated by the histogram generator may include the first histogram and the second histogram, and
the two or more duplicate histograms generated by the duplicate histogram generator may include the first duplicate histogram and the second duplicate histogram.

The light receiving section may include a plurality of pixels arranged in two or more in each of a first direction and a second direction, and
each of the plurality of pixels may receive the two or more reflected light pulse signals within the two or more time ranges.

The photodetection device may further include a packet generator that generates ranging data including the two or more histograms in units of frames,
in which the ranging data may include a start section, a plurality of packets, and an end section,
the start section may include an identifier indicating a head of a frame and a number of the two or more time intervals,
the packet may include a header including a bin count of a histogram corresponding and a number of the plurality of pixels in the two or more histograms, histogram data constituting the histogram corresponding, and a footer including end information of the histogram corresponding, and
the end section may include an identifier indicating an end of the frame.

The photodetection device may further include a packet generator that generates ranging data including the two or more histograms in units of frames,
in which the ranging data may include a start section, a plurality of packets, and an end section,
the start section may include an identifier indicating a head of a frame, a number of the plurality of pixels, and a number of the two or more time intervals,
the packet may include a header including information indicating a pixel position, histogram data constituting the histogram corresponding among the two or more histograms, and a footer including end information of the histogram corresponding, and
the end section may include an identifier indicating an end of the frame.

The photodetection device may further include a ranging section that measures a distance of the object on the basis of a light reception time in a case where light reception times corresponding to peak positions of the two or more duplicate histograms including the first duplicate histogram and the second duplicate histogram match each other or a light reception time corresponding to a maximum peak position of a reconstructed histogram synthesized by aligning bin counts of the two or more duplicate histograms.

The ranging section may add the two or more duplicate histograms for each bin to generate the reconstructed histogram.

Each of the two or more duplicate histograms may have same bin count, and
the ranging section may search for a same bin in which each of the two or more duplicate histograms has a peak value of a light reception frequency, and generate the reconstructed histogram on the basis of a minimum peak value in the bin searched.

The photodetection device may further include a plurality of time digital converters and a plurality of the histogram generator arranged for each first pixel group including two or more of the pixels arranged in the first direction,
in which each of the plurality of time digital converters may sequentially generate a digital signal according to a reception time of the two or more reflected light pulse signals received by each pixel in the first pixel group corresponding, and
each of the plurality of the histogram generator may generate the two or more histograms on the basis of the digital signal sequentially generated by the time digital converter corresponding.

A plurality of second pixel groups each including two or more of the pixels arranged in the second direction may be arranged in the first direction, and
the plurality of the second pixel groups may be sequentially selected, and each pixel in the second pixel group selected may input light reception signals corresponding to the two or more reflected light pulse signals to the plurality of time digital converters in parallel.

Each pixel in the second pixel group selected may sequentially output two or more light reception signals according to the two or more reflected light pulse signals in one frame period, and the light reception signals output of the respective pixels in the second pixel group may be input to the plurality of time digital converters in parallel.

The photodetection device may further include a plurality of time digital converters and a plurality of the histogram generator arranged for each of the pixels,
in which each of the plurality of time digital converters may generate a digital signal corresponding to a reception time of the two or more reflected light pulse signals received by a pixel corresponding, and
each of the plurality of the histogram generator may generate the two or more histograms on the basis of the digital signal generated by the time digital converter corresponding.

Each of the plurality of pixels may sequentially output two or more light reception signals according to the two or more reflected light pulse signals in one frame period, and the light reception signals output of the respective pixels may be input to the plurality of time digital converters in parallel.

The time digital converter may output a gray code corresponding to a light reception time, and
the histogram generator may include a conversion table for converting the gray code into light reception time data.

The photodetection device may further include a storage section that stores the two or more duplicate histograms having a bin count corresponding to a least common multiple of the two or more time intervals.

The photodetection device may further include a storage section having a storage capacity corresponding to a bin count of the histogram corresponding to a maximum time interval among the two or more time intervals.

The photodetection device may further include:
a bin expanding section that stores the histogram corresponding to the maximum time interval in the storage section as one unit and expands the histogram corresponding to the two or more time intervals excluding the maximum time interval in the one unit and stores the histogram in the storage section;
a peak detecting section that repeats, for each of a plurality of the one unit, a process of detecting a place where light reception times of peaks of the two or more histograms match each other in a storage area of the storage section including the two or more histograms corresponding to the two or more time intervals in each one unit;
a maximum peak detecting section that detects a maximum value of the peak from among the plurality of the one unit;
a shift section that shifts the maximum value of the peak to a center in the storage area corresponding; and
a centroid calculation section that performs a centroid calculation in the storage area shifted by the shift section.

The histogram generator may generate the two or more histograms on the basis of the two or more reflected light pulse signals repeatedly obtained when the light pulse signal is repeatedly caused to emit light at each of the two or more time intervals, and flatten a number of frequencies other than peaks of the two or more histograms by periodically shifting start times when the two or more histograms are generated.

The photodetection device may further include an interference detecting section that detects presence or absence of interference by an unknown light pulse signal,
in which the ranging section may measure the distance of the object on the basis of the reconstructed histogram in a case where the interference detecting section detects that there is no interference.

The photodetection device may further include a synchronization determination section that determines whether or not synchronization with cycle switching of the unknown light pulse signal is possible when the interference is detected by the interference detecting section,
in which the histogram generator may generate the two or more histograms in synchronization with the unknown light pulse signal when the synchronization determination section determines that synchronization is possible.

The photodetection device may further include a cycle detecting section that detects a switching order of a cycle of the unknown light pulse signal,
in which the histogram generator may generate the two or more histograms in a switching order in which the switching order of the cycle detected by the cycle detecting section is temporally shifted or in a switching order different from the switching order of the cycle detected by the cycle detecting section.

The photodetection device may further include a light emission timing control section that controls a light emission timing of a light pulse signal including the first light pulse signal and the second light pulse signal such that interference with the unknown light pulse signal is mitigated when the synchronization determination section determines that synchronization is impossible.

The light emission timing control section may randomize light emission periods of two or more light pulse signals used to generate each of a plurality of histograms included in each of the two or more duplicate histograms.

The light emission timing control section may randomize the light emission periods of the two or more light pulse signals such that a total number of light pulse signals used to generate the plurality of histograms is equal for each of the two or more duplicate histograms.

Furthermore, according to the present disclosure, there is provided a ranging system including: a light emitting device; and a photodetection device, in which
the light emitting device includes:
a first light emitting section that emits a plurality of the first light pulse signal at the first time interval; and
a second light emitting section that emits a plurality of the second light pulse signal at the second time interval, and
the photodetection device includes a light emission timing control section that controls the first light emitting section and the second light emitting section such that after the first light emitting section emits the first light pulse signal in a number corresponding to the first time range at the first time interval, the first light emitting section emits the second light pulse signal in a number corresponding to the second time range at the second time interval.

The light emitting device may emit each of the two or more light pulse signals by a number corresponding to the time range corresponding at the two or more time intervals, and
the light emission timing control section may perform control to sequentially emit the two or more light pulse signals.

The photodetection device may include an interference detecting section that detects an unknown light pulse signal, and
the light emission timing control section may cause the light emitting device to repeatedly emit light in a sequence different from a sequence of the two or more time intervals at which the unknown light pulse signal detected by the interference detecting section is caused to emit light, or at a time interval different from the two or more time intervals.

The histogram generator may generate the two or more histograms on the basis of the unknown light pulse signal in a state where the light emitting device does not emit light, and
the interference detecting section may detect presence or absence of interference by the unknown light pulse signal on the basis of the two or more histograms.

Furthermore, according to the present disclosure, there is provided a ranging system including:
a light emitting device including
a first light emitting section that emits a plurality of first light pulse signals at a first time interval, and
a second light emitting section that emits a plurality of second light pulse signals at a second time interval;
a light receiving section that receives a first reflected light pulse signal in which the first light pulse signal is reflected by an object within a first time range, and receives a second reflected light pulse signal in which the second light pulse signal emitted at a second time interval different from the first time interval is reflected by the object within a second time range different from the first time range; and
a packet generator that generates ranging data having two or more histograms including a first histogram generated on the basis of the first reflected light pulse signal and a second histogram generated on the basis of the second reflected light pulse signal in units of frames, in which
the ranging data includes a start section, a plurality of packets, and an end section,
the start section includes an identifier indicating a head of a frame and a number of two or more time intervals including the first time interval and the second time interval,
the packet includes a header including a bin count of a histogram corresponding among the two or more histograms, histogram data constituting the histogram corresponding, and a footer including end information of the histogram corresponding, and
the end section includes an identifier indicating an end of the frame.

### BRIEF DESCRIPTION OF DRAWINGS

FIG. 1 is a block diagram illustrating a schematic configuration of a ranging system according to a first embodiment of the present disclosure.

FIG. 2A is a diagram for explaining a basic example of a ranging operation of a dToF scheme.

FIG. 2B is a diagram for explaining a repeated ranging operation.

FIG. 2C is a diagram illustrating a ranging operation in a case where the light round-trip interval is longer than the light emission interval.

FIG. 3 is a diagram illustrating an example in which 16Bin ranging, 14Bin ranging, and 12Bin ranging are sequentially performed by changing each light emission interval of a light emitting section.

FIG. 4A is a schematic diagram illustrating an example in which 16Bin ranging is performed on an object.

FIG. 4B is a schematic diagram illustrating an example in which 14Bin ranging is performed on an object.

FIG. 4C is a schematic diagram illustrating an example in which 12Bin ranging is performed on an object.

FIG. 4D is a schematic diagram illustrating duplicate histograms and peak values.

FIG. 5A is a flowchart of ranging processing of the ranging system.

FIG. 5B is a flowchart of ranging calculation.

FIG. 6 is a diagram illustrating a case where 10Bin ranging, 12Bin ranging, 14Bin ranging, and 16Bin ranging are performed by the ranging system of the present disclosure.

FIG. 7 is a diagram illustrating a detailed first configuration example of a pixel array section in a photodetection device.

FIG. 8 is a timing chart of data transmission from the pixel array section to the SRAM and the ranging section in the first configuration example.

FIG. 9 is a diagram illustrating a detailed second configuration example of the pixel array section in the photodetection device.

FIG. 10 is a timing chart of data transmission from the pixel array section to the SRAM and the ranging section in the second configuration example.

FIG. 11 is a flowchart illustrating processing of the ranging section.

FIG. 12 is a diagram illustrating a ranging section and a peripheral section according to a second embodiment.

FIG. 13A is a diagram illustrating an example of dividing a reconstructed histogram into unit histograms.

FIG. 13B is a flowchart of processing of the ranging section in the second embodiment.

FIG. 13C is a flowchart of processing of a maximum peak detecting section, a shift section, and a centroid calculation section.

FIG. 14A is a diagram illustrating a first configuration example of a ranging system according to a third embodiment.

FIG. 14B is a diagram illustrating a second configuration example of the ranging system according to the third embodiment.

FIG. 15A is a diagram illustrating a first example of ranging data generated by a packet generation section.

FIG. 15B is a diagram illustrating a transmission order of ranging data of the first example.

FIG. 15C is a diagram illustrating a transmission order in a case where a packet of ranging data of the first example has a fixed length.

FIG. 16A is a diagram illustrating a second example of ranging data generated by a packet generation section.

FIG. 16B is a diagram illustrating a transmission order of ranging data of the second example.

FIG. 17A is a diagram illustrating an example in which disturbance radio waves are synchronized with a processing cycle such as exposure rotation.

FIG. 17B is a diagram illustrating an example in which the start code of the time digital converter is changed for each processing cycle.

FIG. 18A is a diagram illustrating an example in which the same number of times of exposure is performed without performing linearity correction in each ranging.

FIG. 18B illustrates an example in which linearity correction of the same number of cycles is performed in each ranging.

FIG. 18C illustrates an example in which linearity correction is performed and the number of times of exposure is added in each ranging.

FIG. 19 is a diagram illustrating an example of a ranging period of 16Bin ranging in a fourth embodiment.

FIG. 20A is a diagram illustrating an example of when a first peak value and a second peak value are obtained in each ranging.

FIG. 20B is a diagram for explaining the reason why the bin affected by the first peak value in FIG. 20A appears.

FIG. 20C is a diagram for explaining a processing operation of a ranging device according to a fifth embodiment.

FIG. 20D is a diagram illustrating an example in which a reconstructed histogram is newly generated after a component of a first peak value is deleted from the duplicate histogram illustrated in FIG. 20B.

FIG. 21 is a flowchart illustrating processing of a ranging section in the fifth embodiment.

FIG. 22 is a block diagram illustrating a time digital converter and a histogram generator in a sixth embodiment.

FIG. 23 is a diagram illustrating gray codes in 16Bin ranging.

FIG. 24A is a diagram illustrating gray codes in 14Bin ranging.

FIG. 24B is a diagram illustrating gray codes in 12Bin ranging.

FIG. 24C is a diagram illustrating gray codes in 10Bin ranging.

FIG. 25A is a diagram for explaining generation of a reconstructed histogram according to a seventh embodiment.

FIG. 25B is a diagram illustrating a relationship between duplicate histograms and count order histograms.

FIG. 26 is a block diagram illustrating a configuration of a ranging section according to the seventh embodiment.

FIG. 27 is a diagram for explaining a method of suppressing an influence of interference light of a ranging system according to an eighth embodiment.

FIG. 28 is a block diagram illustrating an interference suppression section according to the eighth embodiment.

FIG. 29 is a flowchart for implementing the interference light suppression method according to the eighth embodiment.

FIG. 30A is a diagram for explaining the Listen mode in detail.

FIG. 30B is a diagram for explaining a histogram generated in the Listen mode.

FIG. 30C is a diagram illustrating synchronization pull-in.

FIG. 31A is a diagram illustrating a success example of the other-device MOD order detection mode.

FIG. 31B is a diagram illustrating a failure example of the other-device MOD order detection mode.

FIG. 32 is a diagram illustrating an other-device synchronous MOD order change ranging mode.

FIG. 33 is a diagram illustrating an interference mitigation ranging mode.

FIG. 34 is a block diagram depicting an example of schematic configuration of a vehicle control system.

FIG. 35 is a diagram of assistance in explaining an example of installation positions of an outside-vehicle information detecting section and an imaging section.

### MODE FOR CARRYING OUT THE INVENTION

Hereinafter, embodiments of a photodetection device and a ranging system will be described with reference to the drawings. Although main components of the photodetection device and the ranging system will be mainly described below, the photodetection device and the ranging system may have components and functions that are not illustrated or described. The following description does not exclude components and functions that are not illustrated or described.

### First Embodiment

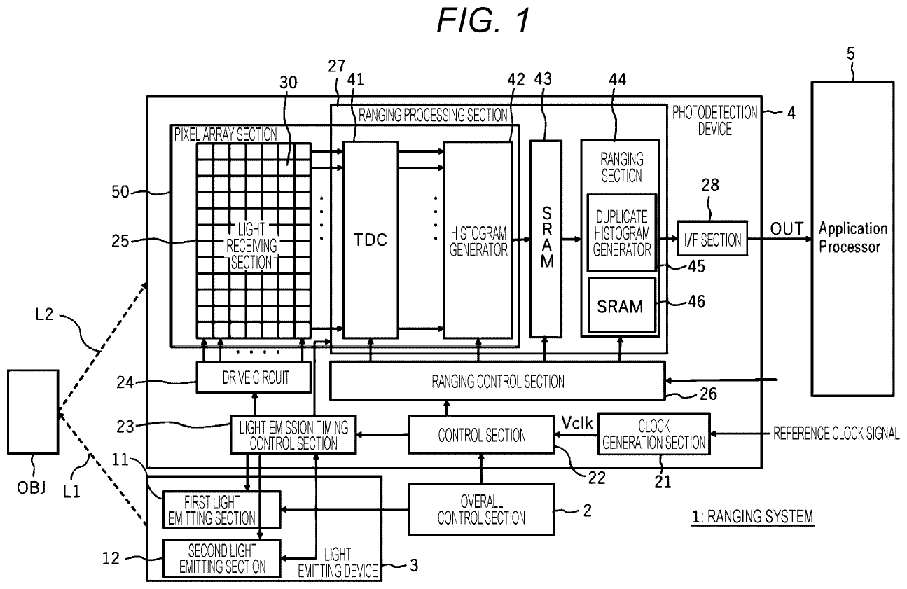

FIG. 1 is a block diagram illustrating a schematic configuration of a ranging system 1 according to a first embodiment of the present disclosure. The ranging system 1 measures a distance to an object OBJ by a dToF scheme, and can be mounted on, for example, an in-vehicle LiDAR or the like. The ranging system 1 includes an overall control section 2, a light emitting device 3, a photodetection device 4, and an application processor (hereinafter, referred to as AP) 5.

Each of the photodetection device 4 and the light emitting device 3 can be configured by a semiconductor chip. In addition, a laminated chip in which a chip incorporating the photodetection device 4 and a chip incorporating the light emitting device 3 are laminated may be configured. Further, a chip for the AP 5 may be laminated on the laminated chip. Alternatively, a chip of the photodetection device 4 and a chip for the AP 5 may be laminated. As described above, at least a part of the components of the ranging system 1 can be configured by one or a plurality of semiconductor chips.

The overall control section 2 controls the light emitting device 3 and the photodetection device 4. The overall control section 2 may be integrated into the photodetection device 4 or the light emitting device 3.

For example, the light emitting device 3 intermittently emits a light pulse signal L1 in a frequency band of near-infrared light. The light emitting device 3 includes a plurality of light emitting sections having different light emission intervals. The light emitting device 3 causes each of the two or more light pulse signals L1 to emit light by the number corresponding to the corresponding time range at two or more time intervals. FIG. 1 illustrates an example in which the light emitting device 3 includes a first light emitting section 11 and a second light emitting section 12, but three or more light emitting sections may be provided. The first light emitting section 11 emits a plurality of first light pulse signals at first time intervals. The second light emitting section 12 emits a plurality of second light pulse signals at second time intervals.

The photodetection device 4 receives the reflected light pulse signal L2 obtained by irradiating the object OBJ with the light pulse signal L1 from the light emitting device 3 and reflecting the light pulse signal L1, and calculates the distance to the object OBJ. The photodetection device 4 includes a clock generation section 21, a control section 22, a light emission timing control section 23, a drive circuit 24, a light receiving section 25, a ranging control section 26, a ranging processing section 27, and an interface (I/F) section 28.

The clock generation section 21 supplies a clock signal Vclk for synchronizing the light emitting device 3 and the photodetection device 4 to the control section 22 on the basis of the reference clock signal.

The control section 22 performs control to synchronize the light emission timing control section 23 and the ranging control section 26 in accordance with the clock signal Volk supplied from the clock generation section 21 and an instruction from the overall control section 2.

Under the control of the control section 22, the light emission timing control section 23 transmits light emission instructions to a plurality of light emitting sections in the light emitting device 3, and performs control to cause the light pulse signal L1 to sequentially emit light. For example, in the example of FIG. 1, the light emission timing control section 23 controls the first light emitting section 11 and the second light emitting section 12 so that after the first light emitting section 11 emits the first light pulse signals in the number corresponding to the first time range at the first time interval, the second light emitting section 12 emits the second light pulse signals in the number corresponding to the second time range at the second time interval.

The light emission timing control section 23 transmits a light emission instruction to the light emitting device 3 and controls the drive circuit 24.

The drive circuit 24 includes a shift register, an address decoder, an aviator, a row selection circuit, a column selection circuit, and the like (not illustrated). The drive circuit 24 drives each pixel 30 arranged in the light receiving section 25 in synchronization with the timing at which the light emission timing control section 23 transmits the light emission instruction.

The light receiving section 25 receives the reflected light pulse signal L2 obtained by irradiating the object OBJ with the light pulse signal L1 from the light emitting device 3 and reflecting the light pulse signal L1. More specifically, the light receiving section 25 includes a plurality of pixels 30 arranged in a two-dimensional direction, and receives the reflected light pulse signal L2 for each pixel 30.

For example, in FIG. 1, the pixel 30 in the light receiving section 25 receives, within a first time range, a first reflected light pulse signal obtained by reflecting, by the object OBJ, a first light pulse signal emitted by the first light emitting section 11 at a first time interval, and receives, within a second time range different from the first time range, a second reflected light pulse signal obtained by reflecting, by the object OBJ, a second light pulse signal emitted by the second light emitting section 12 at a second time interval different from the first time interval. As described above, each of the plurality of pixels 30 receives two or more reflected light pulse signals L2 within two or more time ranges.

The plurality of pixels 30 in the light receiving section 25 supplies a light reception signal indicating a light reception result to the ranging processing section 27.

The ranging control section 26 controls the ranging processing section 27 in synchronization with the light emission timing control section 23 under the control of the control section 22.

The ranging processing section 27 performs ranging calculation by the dToF scheme on the basis of the light reception signals supplied from the plurality of pixels 30. The ranging processing section 27 includes a time digital converter (TDC) 41, a histogram generator 42, an SRAM 43, and a ranging section 44.

The time digital converter 41 counts the time difference between the light emission timing of the light emitting device 3 and the light reception timing of the reflected light pulse signal L2 of the light receiving section 25 in synchronization with the light emission timing control section 23 by the ranging control section 26. The time digital converter 41 supplies a digital signal corresponding to the count value corresponding to the time difference to the histogram generator 42. In this manner, the time digital converter 41 generates a digital signal corresponding to the reception time of the reflected light pulse signal L2 and supplies the digital signal to the histogram generator 42.

The histogram generator 42 generates a histogram in which the light reception frequency is classified for each predetermined fixed unit time on the basis of the digital signal supplied from the time digital converter 41, and stores the histogram in the SRAM 43. For example, in the example of FIG. 1, each pixel 30 in the light receiving section 25 receives the first reflected light pulse signal and the second reflected light pulse signal described above within the first time range and the second time range, respectively. Accordingly, the histogram generator 42 generates a first histogram in which the light reception frequency of the first reflected light pulse signal received within the first time range is classified for each unit period, and generates a second histogram in which the light reception frequency of the second reflected light pulse signal received within the second time range is classified for each unit period.

A plurality of time digital converters 41 and a plurality of histogram generators 42 may be provided. For example, one pixel may be provided for each pixel 30, or one pixel may be provided for each group of pixels 30 arranged in one column. The plurality of pixels 30, the time digital converter 41, and the histogram generator 42 arranged in the two-dimensional direction provided in the light receiving section 25 constitute a pixel array section 50. Details of the pixel array section 50 will be described later.

The SRAM 43 stores the histogram generated by the histogram generator 42.

The ranging section 44 includes a duplicate histogram generator 45 and an SRAM (storage section) 46. The ranging section 44 reads a plurality of histograms (in the example of FIG. 1, the first histogram and the second histogram) from the SRAM 43 and passes the histograms to the duplicate histogram generator 45.

The duplicate histogram generator 45 generates a duplicate histogram obtained by duplicating a plurality of histograms generated by the histogram generator 42. For example, in FIG. 1, a first duplicate histogram obtained by duplicating the first histogram by a first number corresponding to a first time interval is generated, and a second duplicate histogram obtained by duplicating the second histogram by a second number corresponding to a second time interval is generated.

The SRAM 46 stores each duplicate histogram generated by the duplicate histogram generator 45. The SRAM 43 and the SRAM 46 can be integrated.

The ranging section 44 performs various calculations such as centroid calculation on the basis of the light reception time in a case where the light reception times corresponding to the peak positions of the two or more duplicate histograms including the first duplicate histogram and the second duplicate histogram generated by the duplicate histogram generator 45 match each other or the light reception time corresponding to the maximum peak position of a reconstructed histogram to be described later synthesized by aligning the bin counts of the two or more duplicate histograms, and measures the distance of the object OBJ. A ranging value which is a measurement result of the ranging section 44 is supplied to the interface section 28.

The interface section 28 outputs the ranging value supplied from the ranging section 44 to the AP 5 as the output signal OUT.

The AP 5 executes, for example, an operating system, various application software, and the like. The AP 5 executes various arithmetic processing on the basis of the ranging value transmitted from the photodetection device 4. For example, the AP 5 generates a distance image indicating the position and movement of the object OBJ.

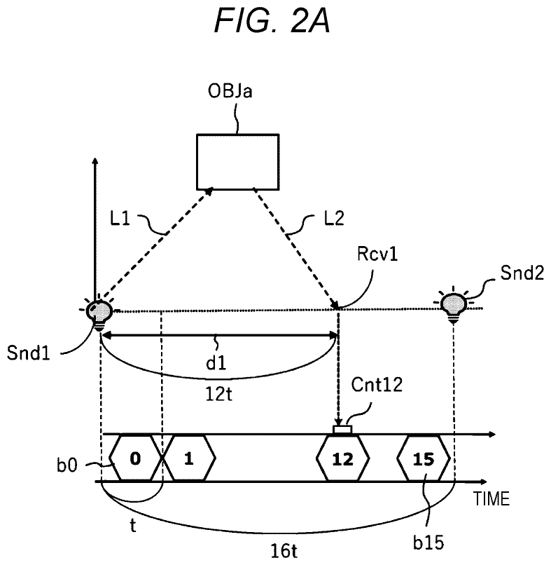

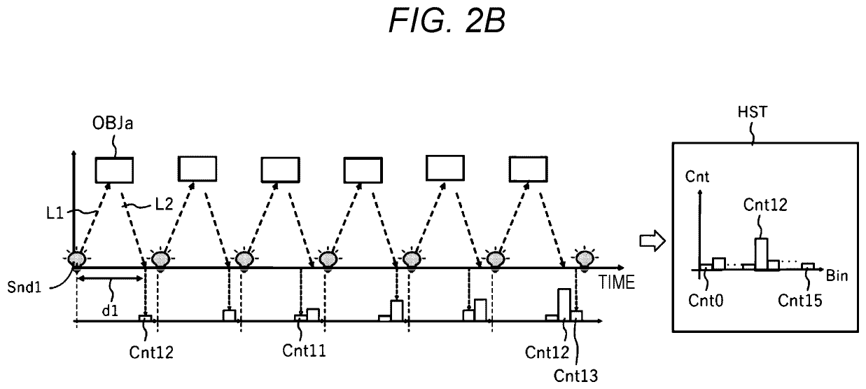

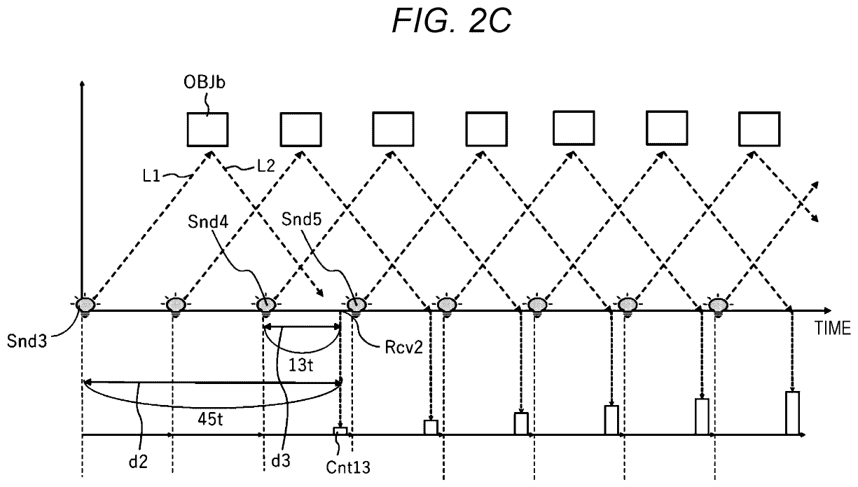

FIG. 2A is a diagram for explaining an outline of a ranging operation of the dToF scheme. In FIG. 2A, the light emitting device 3 intermittently emits a light pulse signal L1 to the object OBJa.

The time digital converter 41 performs counting operation of the light reception timing in synchronization with the light emission of the light emitting device 3. The light emitting device 3 and the time digital converter 41 are synchronized by the clock signal Volk generated by the clock generation section 21. The time digital converter 41 changes the count code every unit time t in synchronization with the clock signal Vclk.

The light emitting device 3 performs a light emitting operation at regular intervals in synchronization with the clock signal Vclk. In the example of FIG. 2A, the light emitting device 3 performs the light emitting operation at the light emission timing Snd1. In addition, the next light emitting operation is performed at a light emission timing Snd2 separated from the light emission timing Snd1 by an interval of 16t which is 16 times the unit time t. The count code of the time digital converter 41 may or may not be reset at intervals of 16t in accordance with the light emission interval of the light emitting device 3. Note that the light emission interval is only required to be an integral multiple of 16 times the unit time t, but in the present specification, an example in which the light emission interval is 16 times the unit time t will be mainly described in order to simplify the description.

The light pulse signal L1 emitted at the light emission timing Snd1 is reflected by the object OBJa, and the reflected light pulse signal L2 from the object OBJa is received by the pixel 30 at the light reception timing Rcv1. A digital signal corresponding to the count code at the light reception timing Rcv1 is output from the time digital converter 41 to the histogram generator 42.

The histogram generator 42 divides the period between the two light emission timings for each unit time t. In the example of FIG. 2A, the interval of 16t is divided into bins b0 to b15. Every time the light emission of the light pulse signal L1 and the light reception of the reflected light pulse signal L2 are repeated, the histogram generator 42 classifies the interval between the light emission timing and the light reception timing into any of the bins b0 to b15, and sequentially updates the light reception frequencies Cnt0 to Cnt15 in bin units.

For example, as illustrated in FIG. 2A, in a case where the interval between the light reception timing Rcv1 and the light emission timing Snd1 (light round-trip interval d1) is the interval of 12t, the histogram generator 42 increases the light reception frequency Cnt12 of the bin b12 by one time.

Note that the fact that the light round-trip interval d1 is an interval of 12t strictly means that the interval between the light reception timing Rcv1 and the light emission timing Snd1 is 12t or more and less than 13t.

FIG. 2B is a diagram for explaining a repeated ranging operation. The ranging operation illustrated in FIG. 2A is repeated within a predetermined time range. FIG. 2B illustrates an example of receiving reflected light from an object OBJa whose light round-trip interval d1 is at an interval of 12t.

In a case where the ranging operation in which the light round-trip interval d1 is an interval of 12t is repeated, the histogram generator 42 sequentially increases the light reception frequency Cnt12 of the bin b12. Due to a slight shift of the light emission timing, a slight movement of the object OBJa, a ranging error caused by a slight shift of the light reception timing, or the like, the light reception timing may be an interval (for example, an interval of 11t or 13t) different from the original interval of 12t. In this case, the histogram generator 42 increases the light reception frequency Cnt11 of the bin b11, the light reception frequency Cnt13 of the bin b13, or the like. As a result, the histogram generator 42 generates the histogram HST with the light reception frequency Cnt12 of the bin b12 as the peak value. The horizontal axis of the histogram HST represents the types of bins b0 to b15, and the vertical axis represents the light reception frequencies Cnt0 to Cnt15.

The histogram HST is read from the histogram generator 42 to the ranging section 44 via the SRAM 43. The ranging section 44 detects the bin b12 having the peak value of the histogram HST. The ranging section 44 performs ranging calculation such as centroid calculation on the basis of the bin b12 and calculates a ranging value.

FIG. 2A illustrates an example in which the interval between the two light emission timings Snd1 and Snd2 is 16t, but the present invention is not limited thereto. For example, in a case where the two light emission timings are set to an interval of 14t, a histogram having the bin count of 14 is generated in the histogram generator 42. Note that, in the present specification, the ranging processing in a case where the histogram generator 42 generates a histogram having the bin count of 16 is referred to as 16Bin ranging. Note that, in the present specification, the 16Bin ranging may be referred to as a Mod16. Further, in the 16Bin ranging, an interval of 16t divided into bins b0 to b15 is also referred to as one exposure rotation.

As described above, in the light emitting device 3 of FIG. 1, the first light pulse signal and the second light pulse signal having different light emission intervals are output in each of the first time range and the second time range. That is, the first histogram and the second histogram generated by the histogram generator 42 in the first time range and the second time range are histograms having different bin counts.

FIG. 2C is a diagram illustrating a ranging operation in a case where the light round-trip interval is longer than the light emission interval. In FIG. 2C, the light pulse signal L1 is emitted at the light emission timing Snd3, whereas the reflected light pulse signal L2 is received at the light reception timing Rcv2 present between the light emission timing Snd4 and the light emission timing Snd5.

FIG. 2C illustrates an example in which 16Bin ranging is performed. As illustrated in FIG. 2C, the true light round-trip interval d2 is 45t. However, in the histogram generator 42, since the interval (false light round-trip interval d3) between the light reception timing Rcv2 and the light emission timing Snd4 immediately before the light reception timing Rcv2 is the interval of 13t, the light round-trip interval is classified into b13, and the light reception frequency Cnt13 of the bin b13 increases. Therefore, also in the ranging section 44, the ranging calculation may be performed on the basis of the false light round-trip interval d3, and an error may occur in the ranging value.

As described above, in the ranging method of the dToF scheme, there is a case where accurate ranging cannot be performed in a case where the light round-trip interval is longer than the light emission interval. The ranging system 1 according to each embodiment described below can solve this problem. In addition, the ranging system 1 according to each embodiment is configured such that the ranging range can be expanded while the bin count is small, and the ranging accuracy, that is, the resolution of the ranging can be improved.

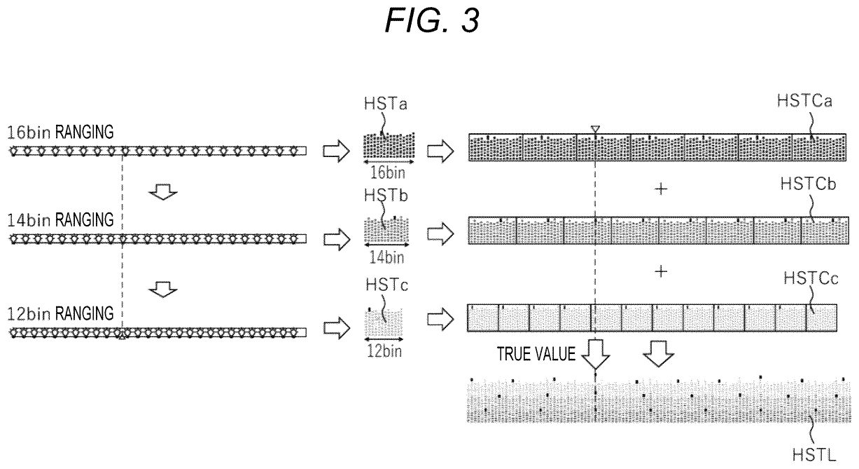

The photodetection device 4 according to the present embodiment receives a plurality of reflected light pulse signals L2 having different light emission intervals, and generates histograms having different bin counts corresponding to the respective reflected light pulse signals L2. The ranging section 44 duplicates and tiles histograms having different light emission intervals, and then overlays the histograms to generate a reconstructed histogram. The ranging section 44 can specify the true light round-trip interval by detecting the peak value of the reconstructed histogram. In FIG. 3, detailed processing contents of the ranging section 44 will be described.

FIG. 3 illustrates an example in which the light emission interval of the light emitting device 3 is changed, and 16Bin ranging, 14Bin ranging, and 12Bin ranging are sequentially performed. In the 16Bin ranging, a histogram HSTa with the bin count of 16 is generated, in the 14Bin ranging, a histogram HSTb with the bin count of 14 is generated, and in the 12Bin ranging, a histogram HSTc with the bin count of 12 is generated.

Although not illustrated in FIG. 1, the light emitting device 3 in the example of FIG. 3 includes three light emitting sections having different light emission intervals. Note that, without providing a plurality of light emitting sections, one light emitting section may switch the light emission interval in three ways, and sequentially emit the light pulse signal L1 at the light emission interval for 16Bin ranging, the light pulse signal L1 at the light emission interval for 14Bin ranging, and the light pulse signal L1 at the light emission interval for 12Bin ranging.

The duplicate histogram generator 45 of FIG. 1 generates duplicate histograms HSTCa, HSTCb, and HSTCc corresponding to the histograms HSTa, HSTb, and HSTc.

The duplicate histogram HSTCa is generated by duplicating the histogram HSTa by the number corresponding to the light emission interval of 16Bin and tiling in the time axis direction. The duplicate histogram HSTCb is generated by duplicating the histogram HSTb by the number corresponding to the light emission interval of 14Bin and tiling in the time axis direction. The duplicate histogram HSTCc is generated by duplicating the histogram HSTc by the number corresponding to the light emission interval of 12Bin and tiling in the time axis direction. Note that tiling is a process of arranging a plurality of duplicated histograms close to each other in the time axis direction. By tiling, the ranging range can be expanded. The ranging section 44 generates a reconstructed histogram HSTL by combining the duplicate histogram HSTCa, the duplicate histogram HSTCb, and the duplicate histogram HSTCc.

In generating the reconstructed histogram HSTL, the duplicate histogram generator 45 needs to align the bin count of the duplicate histograms HSTCa, HSTCb, and HSTCc. Since the least common multiple of the bin count of the histograms HSTa, HSTb, and HSTc is 336, all the bin counts of the duplicate histograms HSTCa, HSTCb, and HSTCc are set to 336.

The duplicate histogram HSTCa can have its bin count increased to 336 by duplicating the histogram HSTa of 16 bins 21 times. Similarly, the duplicate histograms HSTCb and HSTCc can have their bin counts increased to 336 by duplicating the histograms HSTb and HSTc a number of times corresponding to their respective bin counts. As described above, the bin count of each of the histograms HSTa, HSTb, and HSTc is determined according to the light emission interval at the time of ranging. Therefore, the duplicate histogram is generated by duplicating the histogram before duplication by the number corresponding to the light emission interval at the time of ranging.

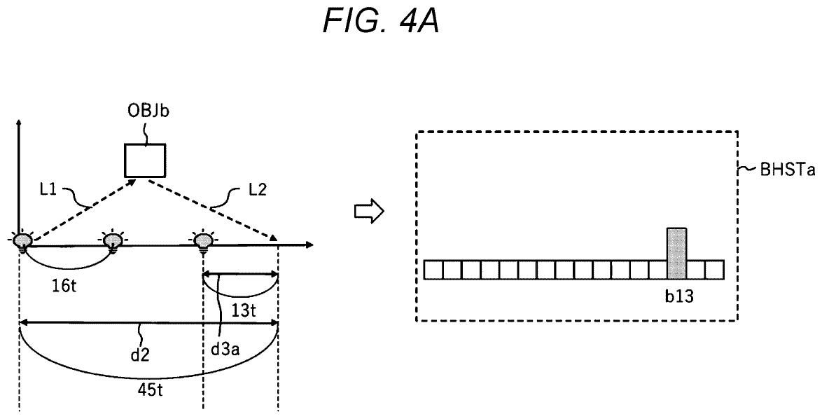

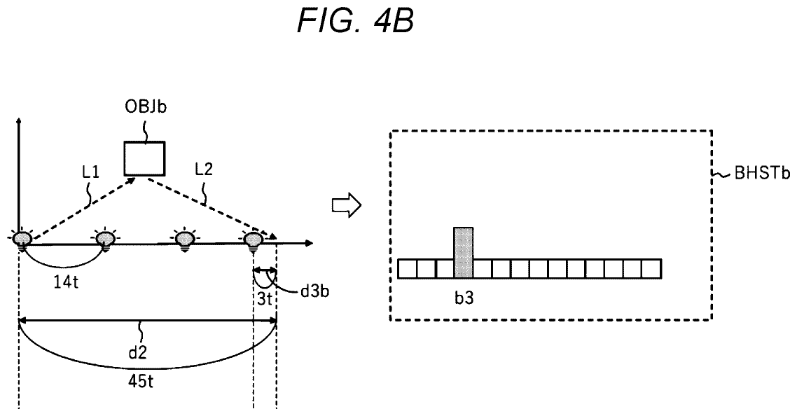

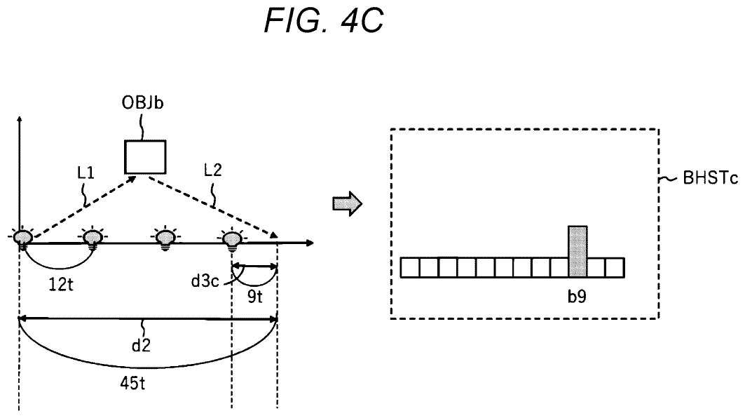

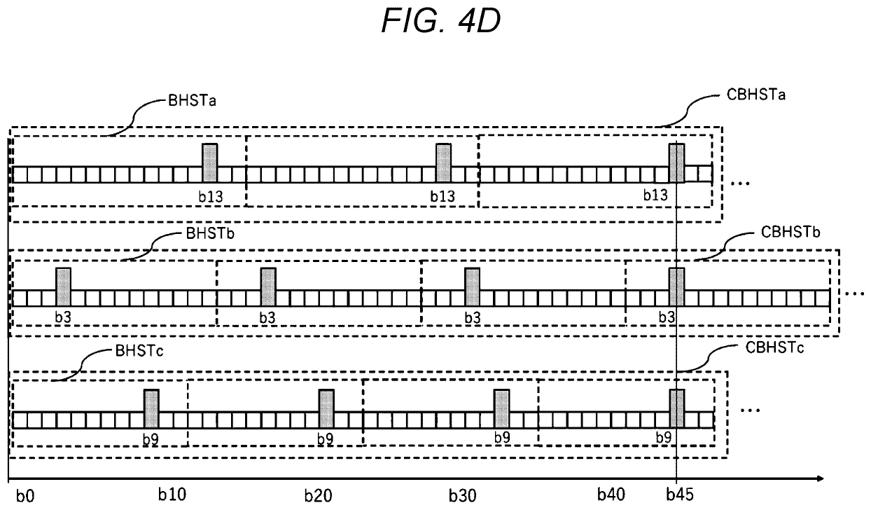

The ranging section 44 generates a reconstructed histogram HSTL having the bin count of 336 by overlaying the duplicate histograms HSTa, HSTb, and HSTc. An accurate ranging value can be calculated from the peak value of the reconstructed histogram HSTL. FIGS. 4A to 4D are diagrams illustrating specific examples of detecting accurate ranging values using histograms HSTa, HSTb, and HSTc.

FIG. 4A is an example in which 16Bin ranging is performed on an object OBJb. Similarly to the example illustrated in FIG. 2C, the true light round-trip interval d2 for the object OBJb is an interval of 45t. At this time, the histogram generator 42 generates a histogram BHSTa with the bin count of 16 having a peak value in the bin b13 on the basis of the false light round-trip interval d3a.

FIG. 4B is an example in which 14Bin ranging is performed on the same object OBJb as in FIG. 4A. FIG. 4C illustrates an example in which 12Bin ranging is performed on the object OBJb. In FIGS. 4B and 4C, similarly to FIG. 4A, histograms are generated on the basis of false light round-trip intervals d3b and d3c, respectively. In FIG. 4B, a histogram BHSTb with the bin count of 14 is generated, with the peak value in bin b3. In FIG. 4C, a histogram BHSTc with the bin count of 12 is generated, with the peak value in bin b9.

FIG. 4D illustrates the duplicate histograms BHSTCa, BHSTCb, and BHSTCc. The duplicate histograms BHSTCa, BHSTCb, and BHSTCc are obtained by duplicating the histograms BHSTa, BHSTb, and BHSTc, respectively, and tiling them in the time axis direction.

As illustrated in FIG. 4D, each of the duplicate histograms BHSTCa, BHSTCb, and BHSTCc has a plurality of peak values. The duplicate histograms BHSTCa, BHSTCb, and BHSTCc commonly have a peak value in bin b45. This bin b45 corresponds to the true light round-trip interval d3 illustrated in FIGS. 4A to 4C. In a case where the duplicate histograms BHSTCa, BHSTCb, and BHSTCc are overlaid to create a reconstructed histogram, the reconstructed histogram has a peak value in bin b45. In the present specification, a peak corresponding to the true light round-trip interval is also referred to as a true peak. In addition, as illustrated in FIG. 4D, the duplicate histograms BHSTCa, BHSTCb, and BHSTCc have one or more peaks in addition to the true peak. Herein, one or more peaks other than a true peak are also referred to as false peaks.

The reconstructed histogram HSTL illustrated in FIG. 3 also has a peak value in a bin corresponding to the true light round-trip interval for the object OBJ, similarly to the example described in FIG. 4D. Therefore, the ranging section 44 can specify the true light round-trip interval by detecting the peak value of the reconstructed histogram HSTL.

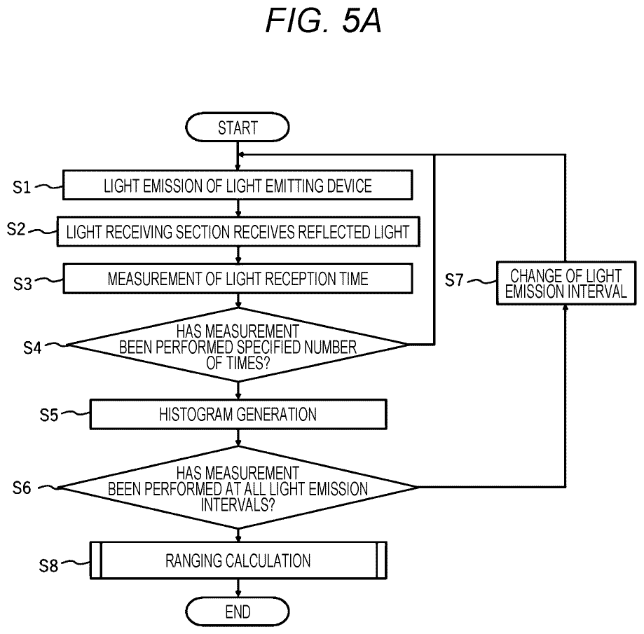

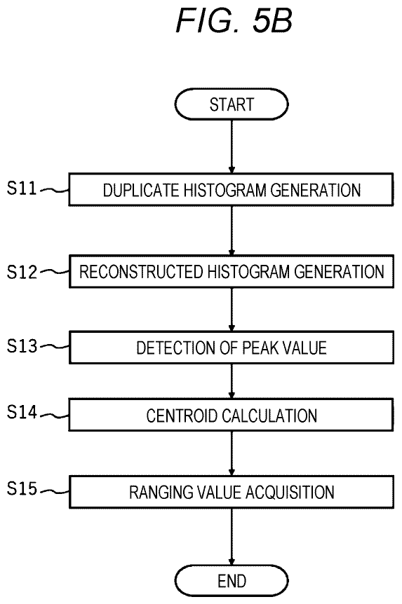

FIG. 5A is a schematic flowchart of ranging processing performed by the ranging system 1 according to the present embodiment. First, the light emitting device 3 emits the light pulse signal L1. In the example of FIG. 1, for example, the first light emitting section 11 irradiates the object OBJ with the first light pulse signal emitted at the first time interval (step S1).

Subsequently, the pixel 30 receives the first reflected light pulse signal reflected from the object OBJ (step S2). Subsequently, the time digital converter 41 generates a digital signal corresponding to the light reception time of the pixel 30 (step S3).

Subsequently, the histogram generator 42 determines whether or not measurement has been performed a specified number of times (step S4). Note that the measurement means reception of the first reflected light pulse signal. In a case where the number of times of measurement is less than the specified number of times, the processing of steps S1 to S3 is repeated. In a case where the number of measurements satisfies the specified number of times, the first histogram is generated on the basis of the digital signal repeatedly output to the histogram generator 42 (step S5). The light reception frequency information of each bin constituting the first histogram is stored in the SRAM 43. Note that, in the present specification, a time range from when the first light emitting section 11 first performs the light emitting operation in step S1 to when the first histogram is generated in step S5 is referred to as a first time range.

Subsequent to step S5, it is determined whether or not measurement has been performed at all light emission intervals (step S6). Subsequently, the light emitting device 3 changes the light emission interval (step S7). In addition to the first light emitting section 11, the light emitting device 3 of FIG. 1 includes the second light emitting section 12 that emits second light pulse signals emitted at second time intervals. Therefore, the light emitting device 3 stops the light emission of the first light emitting section 11 and drives the second light emitting section 12 that emits the second light pulse signal at the second time interval.

Similarly, in the second light emitting section 12, the light receiving section 25 repeatedly performs measurement in the second time range, and the histogram generator 42 generates the second histogram. In step S6, in a case where the light emitting device 3 can emit light at a time interval different from the first time interval and the second time interval, the light emitting device 3 changes the light emission interval in step S7, and then repeatedly performs measurement to generate separate histograms. In a case where the measurement at all the light emission intervals that can be performed by the light emitting device 3 is completed, the ranging calculation is performed (step S8).

FIG. 5B is a diagram illustrating a flowchart of ranging calculation in step S8 of FIG. 5A. First, the ranging section 44 reads two or more histograms including the first histogram and the second histogram from the SRAM 43. The duplicate histogram generator 45 generates two or more duplicate histograms including the first duplicate histogram and the second duplicate histogram (step S11). As described in FIG. 3, the first duplicate histogram and the second duplicate histogram are generated by duplication and tiling of the first histogram and the second histogram.

Subsequently, the ranging section 44 generates a reconstructed histogram by overlaying two or more duplicate histograms including the first duplicate histogram and the second duplicate histogram (step S12). Overlaying two or more duplicate histograms means, for example, adding two or more duplicate histograms for each bin. The ranging section 44 detects a peak value from the generated reconstructed histogram (step S13). The ranging section 44 performs a centroid calculation on the basis of the detected peak value (step S14). The ranging section 44 acquires a ranging value from the result of the centroid calculation (step S15).

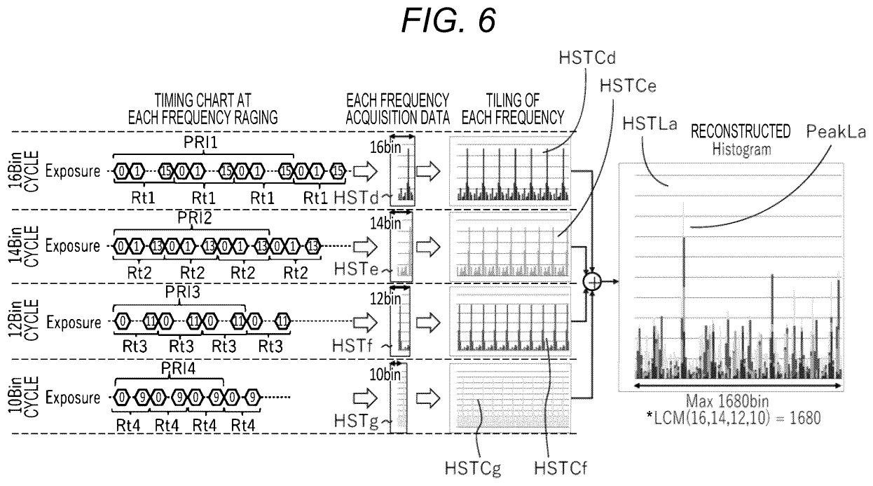

FIG. 6 is a diagram illustrating a case where 10Bin ranging, 12Bin ranging, 14Bin ranging, and 16Bin ranging are performed by the ranging system 1. In the 16Bin ranging, the exposure rotation Rt1 at the above-described intervals of 16t is repeated a plurality of times. The light emitting device 3 may emit light for each exposure rotation Rt1. Further, the period of the plurality of exposure rotations Rt1 may be set as the light emission interval PRI1 of the light emitting device 3. Similarly, also in the 14Bin ranging, the 12Bin ranging, and the 10Bin ranging, the exposure rotation Rt2 at intervals of 14t, the exposure rotation Rt3 at intervals of 12t, and the exposure rotation Rt4 at intervals of 10t are repeated a plurality of times, respectively. In addition, periods of the plurality of exposure rotations Rt2, Rt3, and Rt4 may be set as light emission intervals PRI2, PRI3, and PRI4 of the light emitting device 3, respectively. The light emission interval of the light emitting device 3 is also referred to as a pulse repetition interval (PRI). In addition, in the present specification, ranging according to the first embodiment of the present disclosure may be referred to as multi-frequency ranging because light pulse signals of a plurality of PRIs are used.

The exposure rotation Rt1 in the 16Bin ranging corresponds to steps S1 to S3 in FIG. 5A. The exposure rotation Rt1 is repeated a plurality of times, and the histogram HSTd is generated in step S5 of FIG. 5A. Similarly, 14Bin ranging, 12Bin ranging, and 10Bin ranging are sequentially performed, and histograms HSTe, HSTf, and HSTg are generated.

In step S11 of FIG. 5B, the duplicate histograms HSTCd, HSTCe, HSTCf, and HSTCg are generated on the basis of the histograms HSTd, HSTe, HSTf, and HSTg. In step S12, a reconstructed histogram HSTLa is generated on the basis of the duplicate histograms HSTCd, HSTCe, HSTCf, and HSTCg. In step S13, the peak value PeakLa is detected from the reconstructed histogram HSTLa.

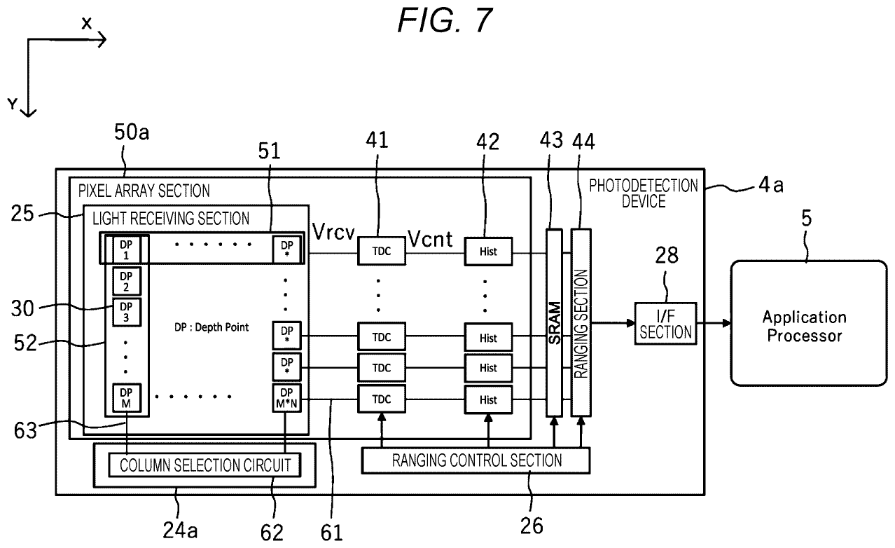

Hereinafter, the detailed operation of the ranging processing will be described with reference to the detailed configuration of the pixel array section 50. FIG. 7 is a diagram illustrating a detailed first configuration example of the pixel array section 50 in the photodetection device 4. The photodetection device 4a illustrated in FIG. 7 includes a pixel array section 50a and a drive circuit 24a.

The drive circuit 24a includes a column selection circuit 62. Each pixel 30 in the pixel array section 50a is controlled by the column selection circuit 62. A plurality of column selection lines 63 extends from the column selection circuit 62 and is connected to the pixels 30. Although not illustrated, the column selection circuit 62 includes a shift register, an address decoder, and the like.

A plurality of pixels 30 is arranged in the row direction X (first direction) and the column direction Y (second direction) within the light receiving section 25, with two or more pixels in each direction. The row direction X is a direction in which the plurality of column selection lines 63 is arranged. The column direction Y is a direction in which each column selection line 63 extends. In addition, in the present specification, two or more pixels 30 arranged in the row direction X are referred to as a first pixel group 51, and two or more pixels 30 arranged in the column direction Y are referred to as a second pixel group 52. A plurality of first pixel groups 51 is arranged in the column direction Y, and a plurality of second pixel groups 52 is arranged in the row direction X.

The pixel array section 50a includes a plurality of time digital converters 41 and a plurality of histogram generators 42 arranged for each first pixel group 51. Note that the plurality of time digital converters 41 and the plurality of histogram generators 42 may be provided separately from the pixel array section 50a. For example, a plurality of time digital converters 41 and a plurality of histogram generators 42 may be provided on a chip different from the chip including the pixel array section 50a, and these chips may be bonded by Cu—Cu bonding or the like. The plurality of pixels 30 in the first pixel group 51 is connected to the time digital converter 41 and the histogram generator 42 by a signal line 61.

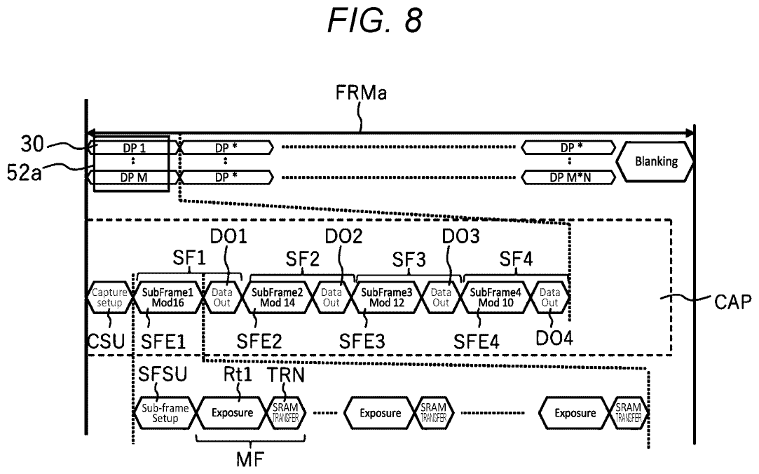

FIG. 8 is a timing chart of data transmission from the pixel array section 50a to the SRAM 43 and the ranging section 44 in the first configuration example of FIG. 7. The pixel array section 50a in FIG. 8 performs 16Bin ranging, 14Bin ranging, 12Bin ranging, and 10Bin ranging in different time ranges (ranging periods SFE1, SFE2, SFE3, and SFE4 to be described later) in one frame period FRMa, and transfers light reception frequency data for each bin of each generated histogram to the ranging section 44.

In the example of FIG. 8, the light emitting device 3 performs light emission at intervals of 16t, 14t, 12t, and 10t in 16Bin ranging, 14Bin ranging, 12Bin ranging, and 10Bin ranging, respectively. That is, each pixel 30 in the light receiving section 25 receives two or more reflected light pulse signals L2 in which two or more light pulse signals L1 emitted at two or more different time intervals are reflected by the object OBJ within two or more different time ranges.

In one frame period FRMa, the capture period CAP is provided for each of the second pixel groups 52. The column selection circuit 62 sequentially selects the plurality of second pixel groups 52. In FIG. 8, an example in which the second pixel group 52a is selected by the column selection circuit 62 will be described. The capture period CAP includes a capture setup period CSU and subframes SF1, SF2, SF3, and SF4. In addition, the subframe SF1 includes a ranging period SFE1 and a data output period DO1.

In the ranging period SFE1, 16Bin ranging in the second pixel group 52a is performed. The ranging period SFE1 includes a subframe setup processing period SFSU and a plurality of mini-frames MF. The mini-frame MF includes the exposure rotation Rt1 illustrated in FIG. 6 and the transfer period TRN to the SRAM 43.

In the exposure rotation Rt1, each pixel 30 in the second pixel group 52a receives the reflected light pulse signal L2 having a light emission interval of 16t in parallel. In parallel, each pixel 30 inputs the corresponding light reception signal Vrcv to the corresponding time digital converter 41.

In the transfer period TRN, each time digital converter 41 to which each light reception signal Vrcv is input supplies the digital signal Vcnt corresponding to the light reception time of the reflected light pulse signal L2 to each histogram generator 42. Each histogram generator 42 generates a histogram with the bin count of 16 on the basis of the supplied digital signal Vcnt and stores the histogram in the SRAM 43.

In the data output period DO1, the histogram generated by each histogram generator 42 is output from the SRAM 43 to the ranging section 44.

As described above, in the mini-frame MF within the ranging period SFE1, the respective pixels 30 of the second pixel group 52a at the left end of the pixel array section 50 sequentially receive the reflected light pulse signal L2 in which the light pulse signal L1 emitted at the light emission interval corresponding to the 16Bin ranging is reflected by the object OBJ in parallel to generate the histogram. The light reception frequency data for each bin constituting the generated histogram is transferred to the SRAM 43 in the transfer period TRN.

A plurality of mini-frame periods MF is provided in the ranging period SFE1. In each mini-frame period MF, basically the same operation is repeated. In some cases, the start code for the time digital converter 41 to generate the digital signal may be changed for each mini-frame period MF.

Subsequently, in the ranging period SFE2 in the subframe SF2, 14Bin ranging in the second pixel group 52a is performed.

The ranging period SFE2 includes a plurality of mini-frames MF having an exposure rotation Rt2.

In the exposure rotation Rt2, each pixel 30 in the selected second pixel group 52a outputs a light reception signal Vrcv corresponding to the reflected light pulse signal L2 having a light emission interval of 14t. That is, each pixel 30 in the selected second pixel group 52a sequentially outputs two or more light reception signals Vrcv according to two or more reflected light pulse signals L2 in one frame period FRMa.

Each histogram generator 42 generates a histogram with the bin count of 14 corresponding to the reflected light pulse signal L2 having the light emission interval of 14t in the SRAM 43 on the basis of the supplied digital signal Vont. That is, the histogram generator 42 generates two or more histograms in which the light reception frequencies of two or more reflected light pulse signals L2 received within two or more time ranges are classified for each unit period.

Subsequently, in the ranging period SFE3 in the subframe SF3, 12Bin ranging in the second pixel group 52a is performed. In the data output period DO3, the data of the histogram with the bin count of 12 is output from the SRAM 43 to the ranging section 44. In the ranging period SFE4 in the subframe SF4, 10Bin ranging in the second pixel group 52a is performed. In the data output period DO4, the histogram with the bin count of 10 is output from the SRAM 43 to the ranging section 44.

The number of mini-frame periods MF included in the ranging period SFE1 may be aligned with that of the other ranging periods SFE2, SFE3, and SFE4.

As described above, the second pixel group 52a includes the plurality of pixels 30 arranged in different first pixel groups 51. In the exposure rotations Rt1, Rt2, Rt3, and Rt4, the plurality of pixels 30 in the second pixel group 52a performs the light receiving processing in parallel. Therefore, the light reception signals Vrcv output from the plurality of pixels 30 in the second pixel group 52a are input in parallel to the plurality of time digital converters 41 arranged for each first pixel group 51. Furthermore, each of the plurality of time digital converters 41 sequentially generates the digital signal Vont corresponding to the light reception time of the two or more reflected light pulse signals L2 received by each pixel 30 in the corresponding first pixel group 51. Each of the plurality of histogram generators 42 generates two or more histograms on the basis of the digital signal Vont sequentially generated by the corresponding time digital converter 41.

When the capture period CAP in the second pixel group 52a ends, the column selection circuit 62 selects the next second pixel group 52. As described above, in the example of FIG. 8, the light receiving operation is performed for each second pixel group 52a arranged in the column direction Y in the pixel array section 50, and each pixel 30 in the second pixel group 52a generates two or more histograms in parallel.

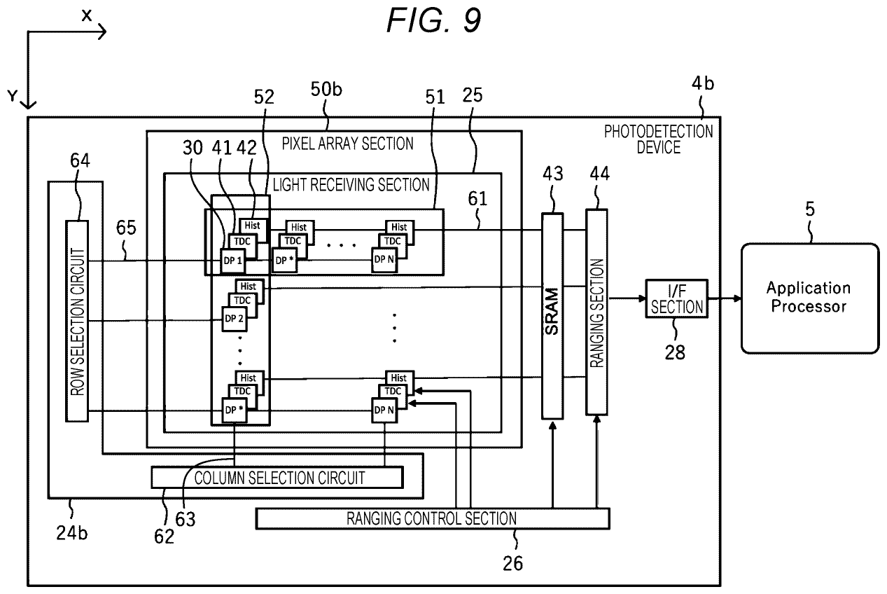

FIG. 9 is a diagram illustrating a detailed second configuration example of the pixel array section 50 in the photodetection device 4. The photodetection device 4b illustrated in FIG. 9 includes a pixel array section 50b and a drive circuit 24b. Unlike the pixel array section 50a in FIG. 7, the pixel array section 50b includes a time digital converter 41 and a histogram generator 42 for each pixel 30.

The drive circuit 24b includes a row selection circuit 64 in addition to the column selection circuit 62 included in the drive circuit 24a of FIG. 7. From the row selection circuit 64, a row selection line 65 extends for each first pixel group 51, and is connected to each pixel 30.

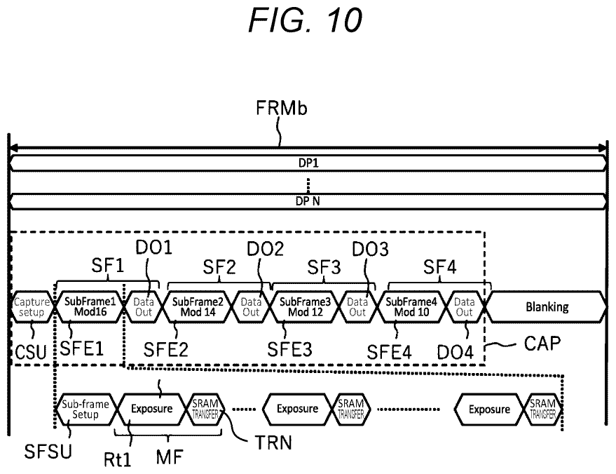

FIG. 10 is a timing chart of data transmission from the pixel array section 50b to the SRAM 43 and the ranging section 44 in the second configuration example of FIG. 9. In the frame period FRMa in FIG. 8, a capture period CAP is provided for each second pixel group 52. On the other hand, in FIG. 10, each pixel 30 has a capture period CAP at a common timing once in one frame FRMb.

In FIG. 10, within the frame FRMb period, each pixel 30 sequentially performs processing of 16Bin ranging, 14Bin ranging, 12Bin ranging, and 10Bin ranging in parallel. That is, each of the plurality of pixels 30 sequentially outputs two or more light reception signals Vrcv corresponding to two or more reflected light pulse signals L2 in one frame period FRMb. The output light reception signal Vrcv of each pixel 30 is input to the corresponding time digital converter 41 in parallel.

Each of the plurality of time digital converters 41 generates a digital signal Vont corresponding to the light reception time of the two or more reflected light pulse signals L2 received by the corresponding pixel 30, and each of the plurality of histogram generators 42 generates two or more histograms on the basis of the digital signal Vont generated by the corresponding time digital converter 41.

As illustrated in FIG. 10, the photodetection device 4b does not require a plurality of capture periods CAP as compared with the photodetection device 4a of FIG. 7. As a result, the photodetection device 4b can perform ranging processing at a higher speed than the photodetection device 4a. Meanwhile, the photodetection device 4a has fewer time digital converters 41 and histogram generators 42 than the photodetection device 4b, and does not require the row selection circuit 64. Therefore, the photodetection device 4a has a simpler structure than the photodetection device 4b, and can be downsized.

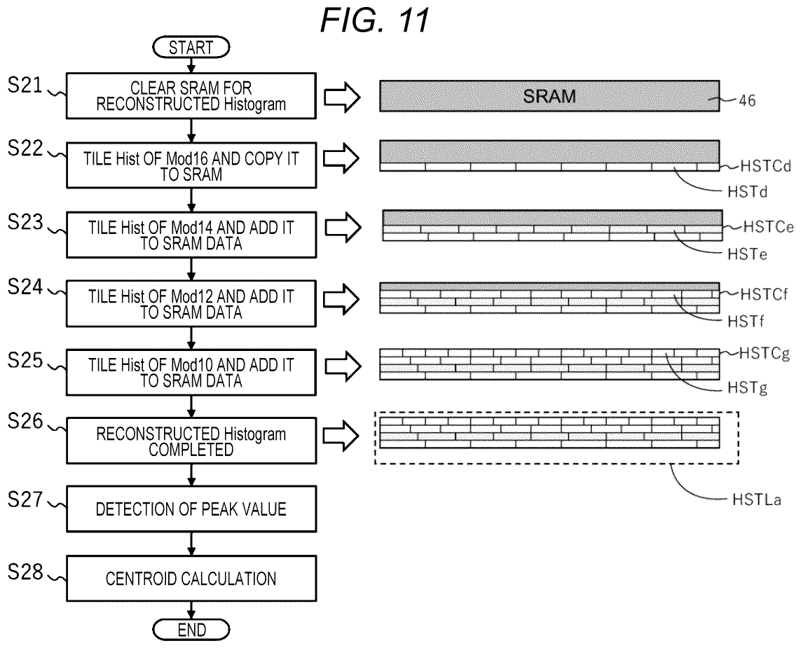

FIG. 11 is a flowchart illustrating processing of the ranging section 44. FIG. 11 is a more specific flowchart of FIG. 5B. Similarly to FIG. 6, FIG. 11 illustrates an example in which 16Bin ranging, 14Bin ranging, 12Bin ranging, and 10Bin ranging are performed. In steps S21 to S28 illustrated in FIG. 11, processing is performed in steps S21 to S26 using the duplicate histogram generator 45 and the SRAM 46.

By the ranging processing described with reference to FIG. 8 or 10, the duplicate histogram generator 45 receives the four histograms HSTd, HSTe, HSTf, and HSTg illustrated in FIG. 6 from the histogram generator 42.

As described above, in order to generate the reconstructed histogram, it is necessary to align the bin count of the four duplicate histograms HSTCd, HSTCe, HSTCf, and HSTCg corresponding to the four histograms HSTd, HSTe, HSTf, and HSTg.

In the example of FIG. 11, the bin count of each duplicate histogram can be aligned by setting the bin count of each duplicate histogram to 1680, which is the least common multiple of 16, 14, 12, and 10. The configuration data of each duplicate histogram is sequentially stored in the SRAM 46, and a reconstructed histogram is generated in the SRAM 46. As described above, the SRAM 46 stores the reconstructed histogram having the bin count corresponding to the least common multiple of the two or more time intervals.

First, the duplicate histogram generator 45 clears the SRAM 46 and secures the capacity to store the reconstructed histogram (step S21). Subsequently, the histogram HSTd having the bin count of 16 is duplicated and tiled to generate a duplicate histogram HSTCd, and the duplicate histogram HSTCd is stored in the SRAM 46 (step S22).

Next, the histogram HSTe with the bin count of 14 is duplicated and tiled to generate a duplicate histogram HSTCe. The duplicate histogram HSTCe is added to the duplicate histogram HSTCd in the SRAM 46 (step S23).

Similarly, the duplicate histogram HSTCf and the duplicate histogram HSTCg are sequentially added to the histogram stored in the SRAM 46 (steps S24 and S25). As a result, the reconstructed histogram HSTLa is generated in the SRAM 46 (step S26).

The ranging section 44 detects a peak value of the reconstructed histogram HSTLa (step S27). The centroid calculation is performed on the basis of the peak value obtained in step S27 to acquire a ranging value (step S28).

As described above, the photodetection device 4 of the present disclosure receives the plurality of reflected light pulse signals L2 having different light emission intervals, and generates two or more histograms having different bin counts. In addition, the photodetection device 4 duplicates, tiles, and overlays two or more histograms to generate a reconstructed histogram. By detecting the peak value of the reconstructed histogram, even in a case where the light round-trip interval is longer than the light emission interval of the light pulse signal L1, a true light round-trip interval can be obtained, and accurate ranging can be performed.

The photodetection device 4 of the present disclosure can accurately perform ranging over a longer distance in a shorter exposure period. Specifically, in a case where ranging as illustrated in FIG. 6 is performed, each exposure period is 16t, 14, 12t, and 10t, and the total is 52t. Meanwhile, the bin count of the reconstruction histogram HSTLa is 1680. Accurate ranging is possible for distances with a light round-trip period of up to 1680t with an exposure period of only 52t. In addition, the bin count required for the histogram generator 42 can also be reduced to 16 to 10, and the area of the histogram generator 42 can be saved.

### Second Embodiment

In the first embodiment, the detection of the peak value and the centroid calculation are performed on the basis of the reconstructed histogram having the bin count corresponding to the least common multiple of two or more time intervals. The reconstructed histogram is generated by duplicating, tiling, and overlaying each histogram generated at each time interval. Therefore, in the reconstructed histogram, the bin count can be reduced without reducing the information amount of the histogram of the duplication source.

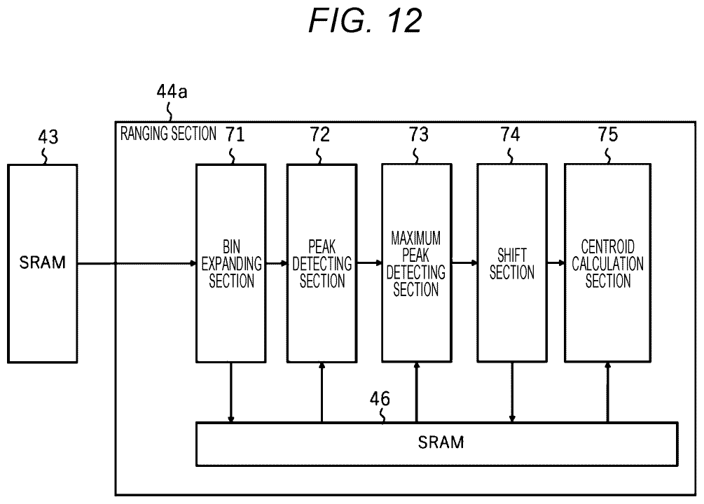

FIG. 12 is a diagram illustrating a ranging section 44a and a peripheral section according to a second embodiment. The ranging section 44a includes a bin expanding section 71, a peak detecting section 72, a maximum peak detecting section 73, a shift section 74, and a centroid calculation section 75.

The bin expanding section 71 reads a plurality of histograms from the SRAM 43. In addition, the bin expanding section 71 stores a histogram corresponding to the maximum time interval in the SRAM 46 as one unit. In addition, histograms corresponding to two or more time intervals except the maximum time interval are expanded to one unit and stored in the SRAM 46. Specifically, for the histogram HSTd illustrated in FIG. 6, the histogram HSTd having the bin count of 16 is stored in the SRAM 46 as one unit. In addition, the histograms HSTe, HSTf, and HSTg are also expanded to the bin count 16 and stored in the SRAM 46.

The SRAM 46 has a storage capacity corresponding to the bin count of the histogram corresponding to the maximum time interval described above.

Each time the bin expanding section 71 newly stores two or more histograms for one unit in the SRAM 46, the peak detecting section 72 performs processing of detecting a place where the light reception times of the peaks of the two or more histograms match in the storage area of the SRAM 46.

The maximum peak detecting section 73 detects a maximum value of a peak from among a plurality of units.

The shift section 74 shifts the maximum value of the peak to the center in the storage area of the corresponding SRAM 46.

The centroid calculation section 75 performs a centroid calculation in the storage area of the SRAM 46 shifted by the shift section 74.

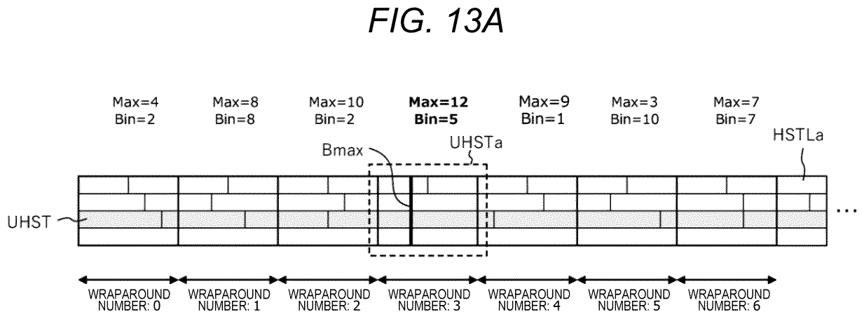

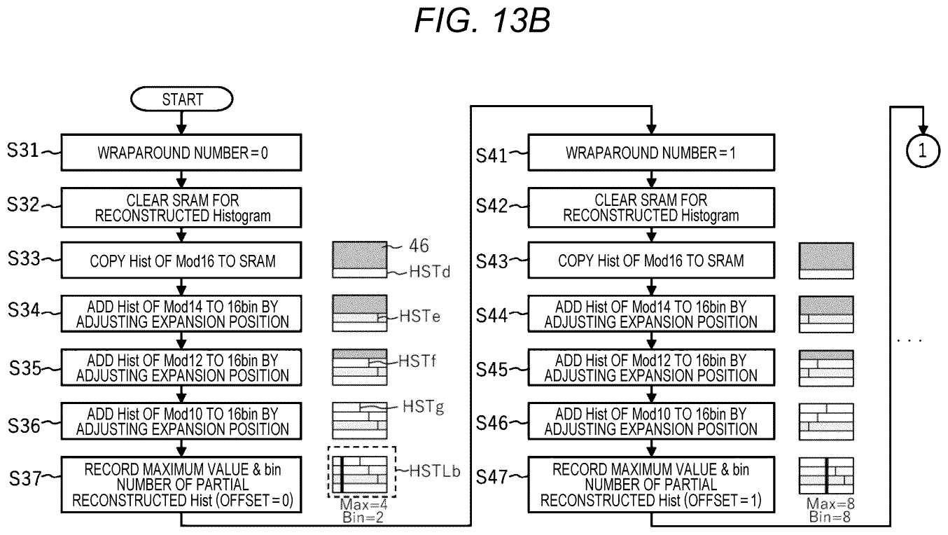

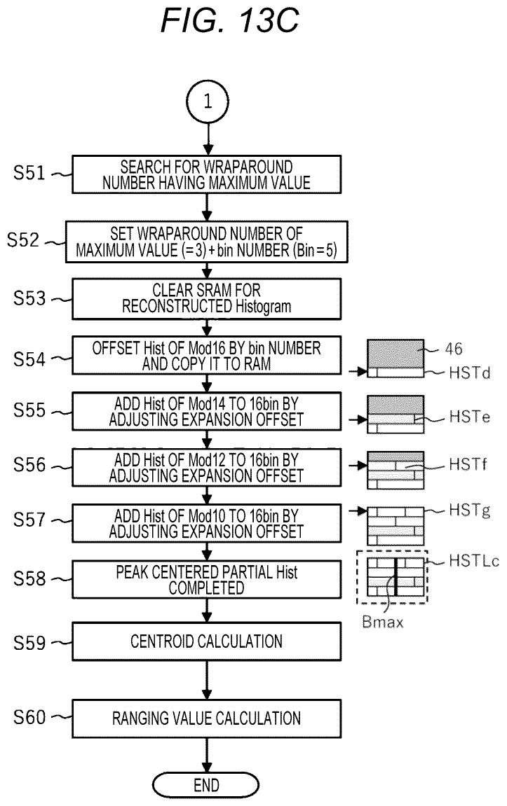

FIGS. 13A, 13B, and 13C are diagrams for explaining the operation of the ranging section 44a. In the following description, processing of detecting a peak value when the histograms HSTd, HSTe, HSTf, and HSTg of FIG. 6 are overlaid will be described.

As illustrated in FIG. 13A, the reconstructed histogram HSTLa in FIG. 6 can be divided into a plurality of unit histograms UHST with the bin count of 16 as one unit. The ranging section 44a repeats the processing of detecting the peak value for each unit histogram UHST, and detects the maximum peak value from all the unit histograms UHST.

One unit histogram UHST is only required to be stored in the SRAM 46 for each detection of the peak value. That is, the unit histogram UHST in the SRAM 46 is only required to be overwritten each time a larger peak value is detected. As a result, the bin count of the histogram stored in the SRAM 46 can be reduced. Note that a wraparound number is allocated from 0 to each unit histogram UHST that is processed for each detection of a peak value. As described above, the wraparound number is an identification number that designates any of the plurality of unit histograms UHST constituting the reconstructed histogram.

FIGS. 13B and 13C are flowcharts illustrating processing operation of the ranging section 44a according to the second embodiment.

Steps S31 to S37 are processing of detecting the peak value for the unit histogram UHST with the wraparound number of 0. In step S31, the ranging section 44a designates the wraparound number as 0.

Steps S32 to S36 are processing in which the bin expanding section 71 generates the unit histogram UHST in the storage area in the SRAM 46. In step S32, the SRAM 46 is cleared. In step S33, the histogram HSTd having the bin count of 16 is duplicated to the SRAM 46.

In step S34, the histogram HSTe with the bin count of 14 is expanded to the bin count of 16 and added to the histogram in the SRAM 46. Specifically, two histograms HSTe are duplicated, and bins b0 to b13 are extracted from one histogram HSTe.

Further, the data of the bins b and b1 is extracted from the other histogram HSTe, and is added to the previously extracted bins b0 to b13 as the bin b14 and the bin b15, respectively. As a result, the histogram HSTe is expanded to the histograms of the bins b0 to b15 and added to the histogram in the SRAM 46.

Similarly, in step S35, the bin count 12 histogram HSTf is expanded to the bin count of 16 and added to the histogram in the SRAM 46. In step S36, processing similar to that in steps S34 and S35 are performed on the histogram HSTg. As a result, the partial reconstructed histogram HSTLb is generated. The partial reconstructed histogram HSTLb corresponds to the unit histogram UHST of the wraparound number=0 included in the reconstructed histogram.

In step S37, the peak detecting section 72 detects a peak value of the partial reconstructed histogram HSTLb. The detected peak value Max (in the example of FIG. 13B, Max=7) and the bin number Bin (in the example of FIG. 13B, Bin=2) at which the peak value is detected are output to the maximum peak detecting section 73. In addition, as the offset value, the value of the wraparound number is output to the maximum peak detecting section 73.

Steps S41 to S47 are processing of detecting the peak value for the unit histogram UHST with the wraparound number of 1. In step S41, the ranging section 44a designates the wraparound number as 1. In steps S42 and S43, the SRAM 46 is cleared, and the histogram HSTd is duplicated to the SRAM 46.

In step S44, the histogram HSTe with the bin count of 14 is offset, expanded to the bin count of 16, and added to the histogram in the SRAM 46. Specifically, two histograms HSTe are duplicated, the data of the bins b0 and b1 already extracted in step S34 is deleted from one histogram HSTe, and the data of the bins b2 to b13 is extracted. In addition, data of bins b0 to b3 is extracted from the other histogram HSTe. The bins b2 to b13 extracted earlier are set as histograms of the bins b0 to b11, and the bins b0 to b3 extracted next are added as bins b12 to b15. As a result, the histogram HSTe is offset by the number of two bins, expanded to the histograms of the bins b0 to b15 to which four bins are added, and added to the histogram in the SRAM 46.

Similarly, in step S45, the histogram HSTf with the bin count of 12 is shifted by the bin count extracted in step S35, expanded to the bin count 16, and added to the SRAM 46. In step S46, processing similar to that in steps S44 and S45 is performed on the histogram HSTg.

In step S47, similarly to step S37, the peak value of the partial reconstructed histogram HSTLb generated in the SRAM 46 is detected, and the peak value Max, the bin number Bin (Max=8, Bin =8), and the offset value are output to the maximum peak detecting section 73.

Similar processing is repeated for the unit histogram UHST with the wraparound number of 2. That is, the SRAM 46 is cleared. In addition, the histogram HSTd is duplicated to the SRAM 46. Subsequently, a histogram expanded to the bin count 16 by shifting the histogram HSTe by the bin count extracted in step S45 is added to the histogram in the SRAM 46. Histograms obtained by performing processing similar to that of the histogram HSTd on the histograms HSTe and HSTf are added to the histogram in the SRAM 46. The peak value detection processing for the calculated partial reconstructed histogram HSTLb is performed.

Similar processing is performed on the unit histogram UHST having the wraparound number of 3 or more included in the reconstructed histogram HSTLa.

FIG. 13C is a diagram illustrating a flowchart of processing of the maximum peak detecting section 73, the shift section 74, and the centroid calculation section 75. The processing of FIG. 13C is performed following the processing of FIG. 13B.

As illustrated in FIG. 13B, the peak value Max, the bin number Bin, and the offset value are repeatedly output to the maximum peak detecting section 73 for the plurality of unit histograms UHST. On the basis of this, the wraparound number of the unit histogram UHST having the maximum peak value Max is searched (step S51).

For example, FIG. 13A illustrates an example in which the unit histogram USHT having the wraparound number of 3 is the unit histogram UHSTa having the maximum peak value Max. The unit histogram UHSTa has the maximum peak value Max in the bin Bmax (in FIG. 13A, bin with Bin=5). The maximum peak detecting section 73 outputs the wraparound number and the bin number Bina of the unit histogram UHSTa to the shift section 74 (step S52).

In steps S53 to S58, the shift section 74 generates, in the SRAM 46, a partial histogram HSTLC centered such that the bin Bmax of the unit histogram UHSTa is located at the center of the 16 bin width.

In step S53, the SRAM 46 is cleared. In step S54, the histogram HSTd is offset in the SRAM 46 such that the bin Bmax is located at the center of the 16 bin width. In step S55, for the histogram HSTe, the offset and expansion similar to those performed for HSTe are performed at the time of generating the unit histogram USHTa in the processing of FIG. 13B. Subsequently, similarly to step S54, the bin Bmax is offset so as to be located at the center of the 16 bin width and added to the histogram in the SRAM 46.

In steps S56 and S57, processing similar to that in step S55 is performed on the histograms HSTf and HSTg. As a result, a partial histogram HSTLc centered such that the bin Bmax is located at the center of the 16 bin width in step S58 is generated in the SRAM 46.

The centroid calculation section 75 performs a centroid calculation on the partial histogram HSTLc (step S59). On the basis of the result of the centroid calculation, the ranging section 44a outputs a ranging value to the interface section 28 (step S60).

As described above, in the second embodiment, it is possible to calculate the ranging value by reducing the bin count of the histogram stored in the SRAM 46. For example, in the ranging calculation processing based on the histograms HSTd, HSTe, HSTf, and HSTg in FIG. 6, the ranging section 44 in the first embodiment needs to store the bin count of 1680 of the reconstructed histogram HSTLa in the SRAM 46. On the other hand, the ranging section 44a according to the second embodiment can reduce the bin count stored in the SRAM 46 to 16.

### Third Embodiment

In the first embodiment, ranging calculation such as centroid calculation is performed inside the photodetection device 4. The ranging calculation can also be performed in the AP 5.

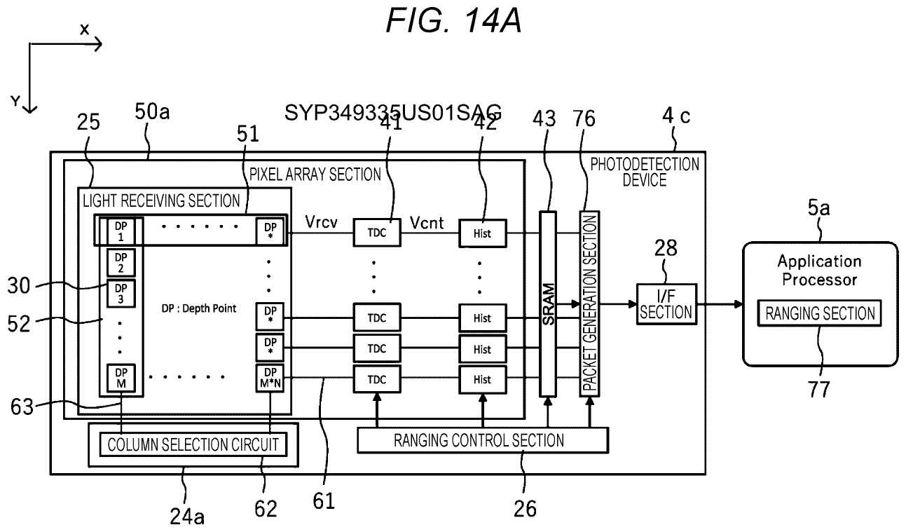

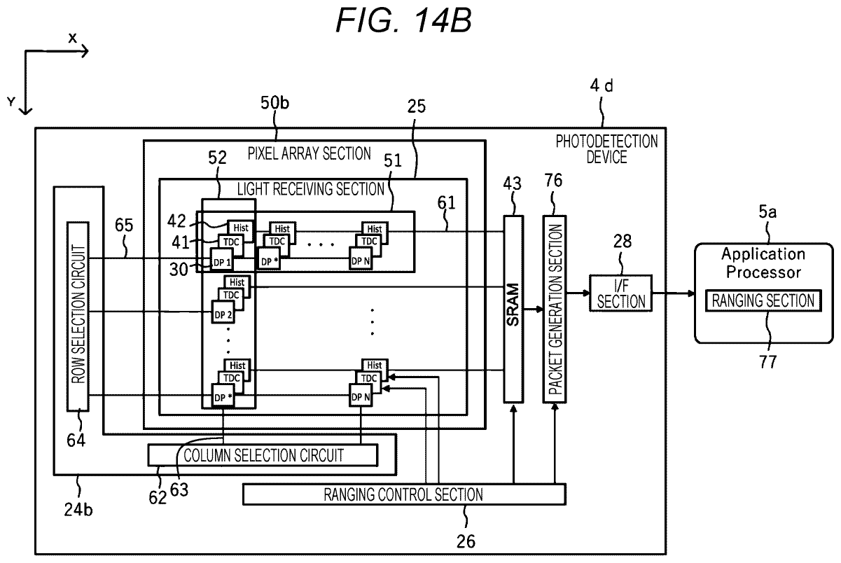

FIG. 14A is a block diagram illustrating a first configuration example of a ranging system according to a third embodiment. As compared with the photodetection device 4a illustrated in FIG. 7, the photodetection device 4c does not include the ranging section 44, but includes a packet generation section 76. In addition, the AP 5a in FIG. 14A includes a ranging section 77.

The packet generation section 76 generates ranging data to be transmitted from the photodetection device 4c to the AP 5a. The ranging data generated by the packet generation section 76 is transmitted to the AP 5a via the interface section.

The AP 5a receives the ranging data transmitted via the interface section 28. The ranging section 77 acquires two or more histograms included in the ranging data and performs, for example, ranging processing similar to that in FIG. 11.

FIG. 14B is a block diagram illustrating a second configuration example of the ranging system according to the third embodiment. The photodetection device 4d in the ranging system of FIG. 14B includes a time digital converter 41 and a histogram generator 42 for each pixel 30 similarly to FIG. 9. In addition, the photodetection device 4d in FIG. 14B includes a packet generation section 76 similarly to FIG. 14A.

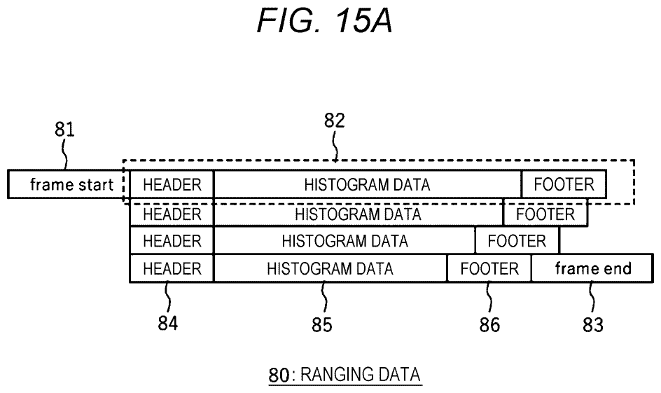

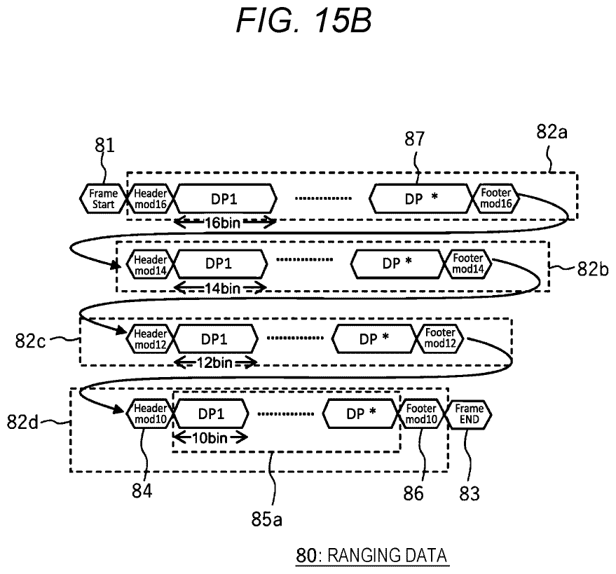

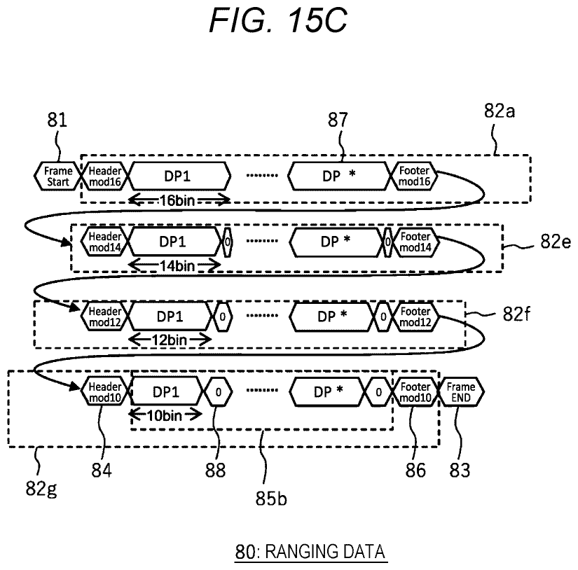

FIG. 15A is a diagram illustrating a first example of ranging data generated by the packet generation section 76. The ranging data 80 illustrated in FIG. 15A includes a start section 81, a plurality of packets 82, and an end section 83.

The start section 81 has an identifier indicating the head of the frame and the number of two or more time intervals (specifically, the light emission interval of the light emitting device 3) at which the light emitting device 3 emits the light pulse signal L1.

Each packet 82 includes a header 84 including the bin count of the corresponding histogram among the two or more histograms and the number of the plurality of pixels 30 in the pixel array section 50, histogram data 85 constituting the corresponding histogram, and a footer 86 including end information of the corresponding histogram. The histogram data 85 includes light reception frequency data of each bin constituting the corresponding histogram.

The end section 83 has an identifier indicating the end of the frame.

The ranging data 80 in FIG. 15A includes the number of packets 82 corresponding to the light emission interval of the light emitting device 3.

As illustrated in FIG. 15A, the packet generation section 76 generates ranging data including two or more histograms in units of frames.

FIG. 15B is a diagram illustrating a transmission order of the ranging data 80 in FIG. 15A. The ranging data 80 illustrated in FIG. 15B is an example in a case where ranging is performed at the light emission intervals of the four light emitting devices 3 as illustrated in FIG. 6. The ranging data 80 includes, as the packet 82, a packet 82a indicating 16Bin ranging data, a packet 82b indicating 14Bin ranging data, a packet 82c indicating 12Bin ranging data, and a packet 82d indicating 10Bin ranging data.

The header 84 includes the bin count of the histogram in each ranging. Specifically, 16 is recorded as the bin count in the header 84 in the packet 82a.

Histogram data 85a is included in each of the packets 82a, 82b, 82c, and 82d. The histogram data 85a includes a histogram 87 generated for each pixel 30.

A histogram 87 with the bin count of 16 is included in the packet 82a.

In the ranging data 80, the bin count of the histogram 87 is different among the packets 82a, 82b, 82c, and 82d. Therefore, the histogram data 85a of the ranging data 80 has a variable length, and the data transfer amount can be minimized.

In the ranging data 80, the packet 82 may have a fixed length. FIG. 15C is a diagram illustrating a transmission order of the ranging data 80 in which the packet 82 has a fixed length. Specifically, a packet 82e indicating data of 14Bin ranging, a packet 82f indicating data of 12Bin ranging, and a packet 82g indicating data of 10Bin ranging include histogram data 85b. In the histogram data 85b, a padding section 88 is added to the histogram 87.

In the case of the packet 82e, the padding section 88 adds padding data for two bin counts to each histogram 87 with the bin count of 14. For example, 0 is added as padding data.

In the ranging data 80 illustrated in FIGS. 15A to 15C, separate packets 82 are provided for each light emission interval of the light emitting device 3. For example, the photodetection device 4b illustrated in FIG. 14B can sequentially perform ranging processing for each light emission interval of the light emitting device 3. In addition, the photodetection device 4b can generate a histogram for each pixel 30. In this case, the packet generation section 76 can generate the packets 82 in the data transfer order. That is, it is not necessary to rearrange the histogram data or the like in the packet generation section 76, and the ranging data can be generated at high speed.

Meanwhile, the ranging section 77 in the AP 5a needs to extract data of the pixel 30 to be subjected to the ranging calculation from the plurality of packets 82 when performing the ranging calculation for each pixel 30.

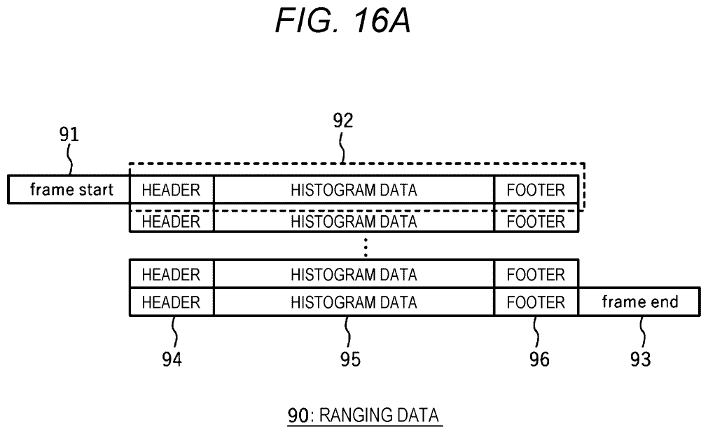

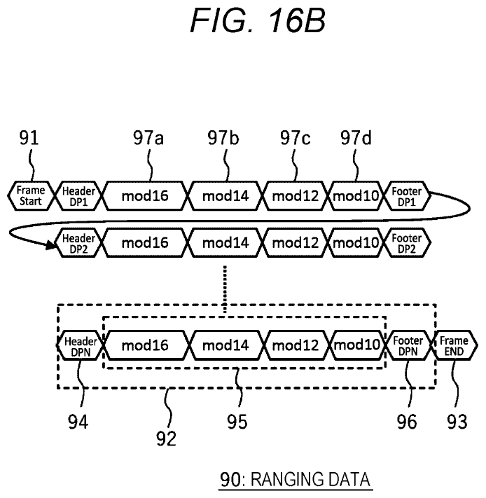

The packet generation section 76 may rearrange the histogram data for each pixel 30. FIG. 16A is a diagram illustrating a second example of ranging data generated by the packet generation section 76. The ranging data 90 illustrated in FIG. 16A includes a start section 91, a plurality of packets 92, and an end section 93.

The start section 91 has an identifier indicating the head of the frame, the number of the plurality of pixels 30, and the number of two or more time intervals (light emission intervals of the light emitting device 3).

One packet 92 includes a header 94 including information indicating the position of the pixel 30, histogram data 95 constituting a corresponding histogram among the two or more histograms, and a footer 96 including end information of the corresponding histogram.

The end section 93 has an identifier indicating the end of the frame.

FIG. 16B is a diagram illustrating a transmission order of the ranging data 90. The ranging data 90 illustrated in FIG. 16B is an example in a case where ranging is performed at the light emission intervals of the four light emitting devices 3 as illustrated in FIG. 6. The ranging data 90 includes a packet 92 for each pixel 30.

The histogram data 95 includes a histogram 97a with the bin count of 16, a histogram 97b with the bin count of 14, a histogram 97c with the bin count of 12, and a histogram 97d with the bin count of 10. The histogram data 95 has a fixed length.

As described above, in the third embodiment, in order to provide the ranging section 77 in the AP 5a, the ranging data including the histogram data is transmitted from the photodetection devices 4c and 4d to the AP 5a. As a result, similarly to the first and second embodiments, the ranging section 77 can generate two or more duplicate histograms and reconstructed histograms, and can accurately measure the distance of the object OBJ from the peak position. In the third embodiment, since it is not necessary to provide the ranging section in the photodetection devices 4c and 4d, the structure of the photodetection device 4 can be simplified, and the photodetection device 4 can be downsized. In addition, in the first and second embodiments, it is necessary to provide a ranging section in the photodetection device to generate two or more duplicate histograms and reconstructed histograms, and to provide a processor having high-performance processing capability in the photodetection device. On the other hand, in the third embodiment, since two or more duplicate histograms and reconstructed histograms are originally generated by the AP 5 having a high-performance processing capability, it can be implemented without changing hardware from the existing ranging system.

### Fourth Embodiment

In the first to third embodiments, the start code of the time digital converter 41 is fixed for each exposure rotation. On the other hand, in a fourth embodiment described below, the ranging accuracy is improved by changing the start code of the time digital converter 41 for each exposure rotation.

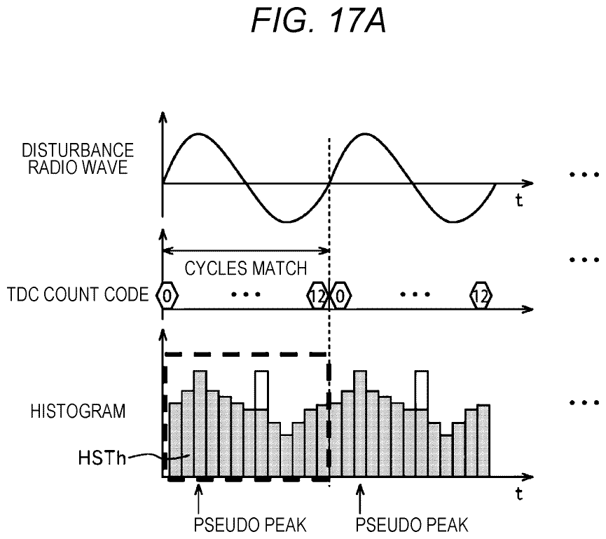

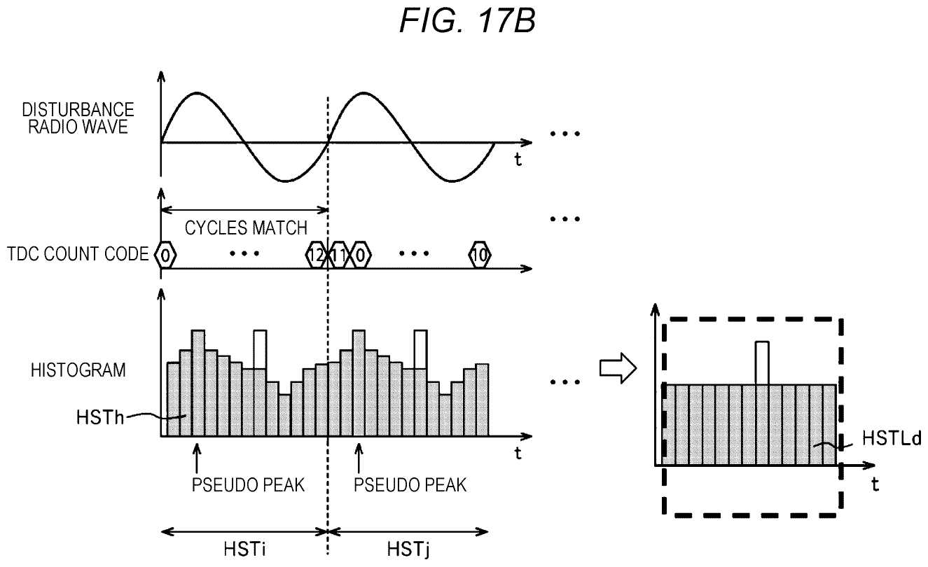

As illustrated in FIG. 17A, in a case where the disturbance radio wave is synchronized with the processing cycle such as exposure rotation (the frequency f of the disturbance radio wave =1/processing cycle), the count may be modulated with the disturbance radio wave as a standing wave. As a result, a pseudo peak as illustrated in the histogram HSTh may occur due to the influence of noise due to the disturbance radio wave.

On the other hand, FIG. 17B illustrates an example in which the start code of the time digital converter 41 is changed for each processing cycle. FIG. 17B illustrates an example of 13Bin ranging that generates a histogram having 13 bins, but the bin count of the histogram is arbitrary. In the example of FIG. 17B, the start code of the time digital converter 41 is set to 0 in the first exposure rotation. That is, in the first exposure rotation, the count code of the time digital converter 41 is incremented from 0 to 12 to generate the histogram HSTi. Subsequently, in the second exposure rotation, the start code of the time digital converter 41 is set to, for example, 11. That is, in the second exposure rotation, after the count code is incremented from 11 to 12, the count code is reset to 0, and the count code is incremented from 0 to 10 to generate the histogram HSTj. As a result, the position of the pseudo peak caused by the disturbance radio wave can be shifted.

Like the histograms HSTi and HSTj, a plurality of histograms in which the start codes of the time digital converter 41 at the time of generating the histogram are periodically shifted is generated and overlaid, whereby the pseudo peaks can be dispersed. As a result, as illustrated in the reconstructed histogram HSTLd on the right side of FIG. 17B, a reconstructed histogram obtained by flattening portions other than the peaks of the histograms HSTi and HSTj can be generated.

Note that the histogram HSTj is offset by the start code of the time digital converter 41 and overlaid in the histogram addition processing in the ranging section 44 illustrated in FIG. 11 or FIGS. 13A to 13C.

In the present specification, the processing of periodically shifting the start code of the time digital converter 41 and flattening the pseudo peak caused by the disturbance radio wave described above is referred to as linearity correction.

Here, the cycle of the linearity correction needs to match the cycle of the ranging. Specifically, in the 16Bin ranging, it is necessary to perform linearity correction of a 16Bin cycle.

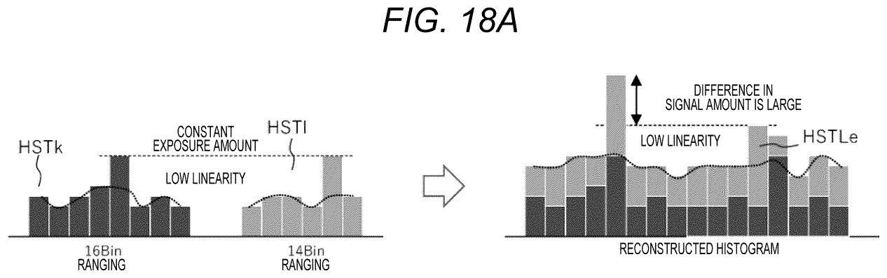

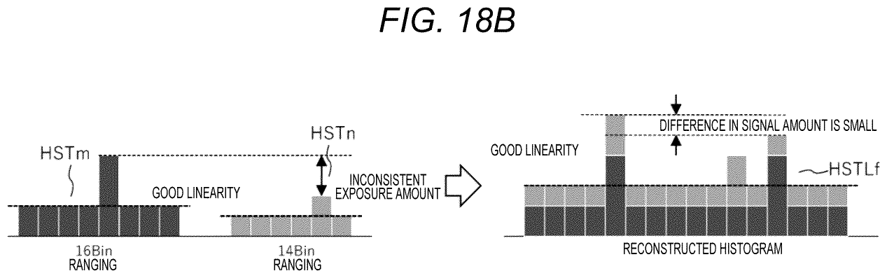

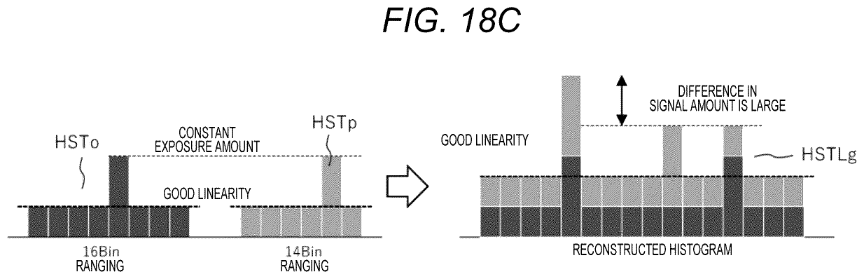

FIG. 18A illustrates an example in which the same number of times of exposure is performed without performing the linearity correction in the 16Bin ranging and the 14Bin ranging, for example. In this case, the pseudo peak caused by the disturbance radio wave cannot be flattened in the histograms HSTK of the 16Bin ranging and HST1 of the 14Bin ranging and the reconstructed histogram HSTLe obtained by duplicating and overlaying the histograms HSTk and HST1. Therefore, the ranging accuracy is deteriorated. Meanwhile, in FIG. 18A, since the number of times of exposure is the same in the 16Bin ranging and the 14Bin ranging, that is, the exposure amount is constant in the 16Bin ranging and the 14Bin ranging, the difference in signal amount between the maximum peak value of the reconstructed histogram and the second and subsequent peak values increases, and the success probability of ranging increases.

Meanwhile, even in a case where the number of times of exposure is different between the 16in ranging and the 14Bin ranging, the ranging accuracy decreases. For example, in a case where the linearity correction of 16Bin cycles is performed for 10 cycles in 16Bin ranging, the number of times of exposure is 160 times. Furthermore, in a case where the linearity correction of the 14Bin cycle is performed for 10 cycles in the 14Bin ranging, the number of times of exposure is 140 times. When the same number of cycles of linearity correction is performed in the 16Bin ranging and the 14Bin ranging, a difference occurs in the number of times of exposure.

FIG. 18B illustrates an example in which the linearity correction of the same number of cycles is performed in 16Bin ranging and 14Bin ranging. Since the number of times of exposure is different, there is a difference in the number of times of light reception (signal amount) used to generate the histogram between the histogram HSTm for 16Bin ranging and the histogram HSTn for 14Bin ranging.

In the reconstructed histogram HSTLf in which the histograms HSTm and HSTn are overlaid, the peak value of the histogram HSTm can be apparent, and the ranging accuracy is improved. However, since the number of times of exposure differs between the 16Bin ranging and the 14Bin ranging, the difference in signal amount between the maximum peak value and the second and subsequent peak values in the reconstructed histogram HSTLf decreases, and the success probability of the ranging decreases.

FIG. 18C illustrates an example in which the linearity correction is performed and the number of times of exposure is added in the 16Bin ranging and the 14Bin ranging. In the histogram HSTo of the 16Bin ranging and the histogram HSTp of the 14Bin ranging, pseudo peaks caused by disturbance radio waves are flattened, and the number of times of light reception of peak values substantially matches. As a result, in the reconstructed histogram HSTLg in which the histograms HSTo and HSTp are overlaid, the peak value becomes apparent, and the ranging accuracy can be improved. Furthermore, in FIG. 18A, since the exposure amount is constant in the 16Bin ranging and the 14Bin ranging, the success probability of the ranging also increases.

If the number of times of exposure is set to the number of times according to the least common multiple of the cycles of each ranging, the number of times of exposure can be matched by a plurality of Bin rangings. Specifically, in a case where 16Bin ranging, 14Bin ranging, 12Bin ranging, and 10Bin ranging are performed, it is possible to match the number of times of exposure of each ranging with a least common multiple of 1680 of each bin count of 16, 14, 12, and 10. That is, by performing 16Bin ranging 105 times, 14Bin ranging 120 times, 12Bin ranging 140 times, and 10Bin ranging 168 times, it is possible to match the number of times of exposure of each Bin ranging, that is, to make the exposure amount constant.

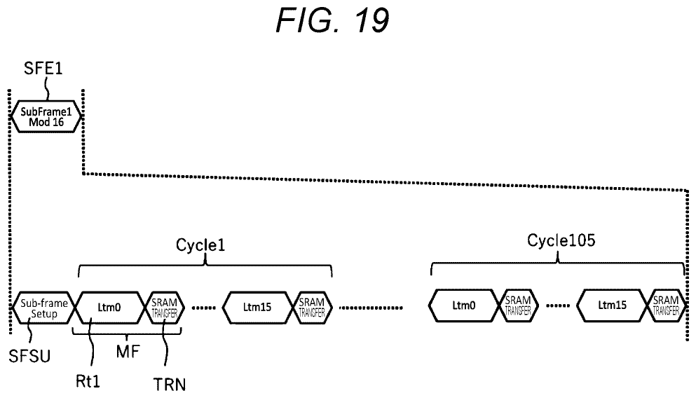

FIG. 19 is a diagram illustrating an example of a ranging period SFE1 of 16Bin ranging in the fourth embodiment. As illustrated in FIG. 8, the ranging period SFE1 includes a plurality of exposure rotations Rt1. In FIGS. 19, 16 exposure rotations Rt1 are set as one cycle. In one cycle, the start code of the time digital converter 41 is changed for each exposure rotation Rt1 to perform linearity correction. By repeating the cycle including such linearity correction 105 times (Cycle1 to Cycle105), the number of times of exposure can be set to 1680. It similarly applies to 14Bin ranging, 12Bin ranging, and 10Bin ranging.

As described above, in the fourth embodiment, the start code of the time digital converter 41 is periodically shifted to perform the linearity correction for flattening the pseudo peak caused by the disturbance radio wave, and the number of times of exposure for each ranging is made to match each other. As a result, the success probability of the ranging can be improved, and the ranging accuracy can be improved. The fourth embodiment can be applied to any of the first to third embodiments.

### Fifth Embodiment

In the first to fourth embodiments, the method for detecting one peak value from the reconstructed histogram has been described. A plurality of peak values can also be detected from the reconstructed histogram. A fifth embodiment is effective for performing ranging for a plurality of objects OBJ or the like.

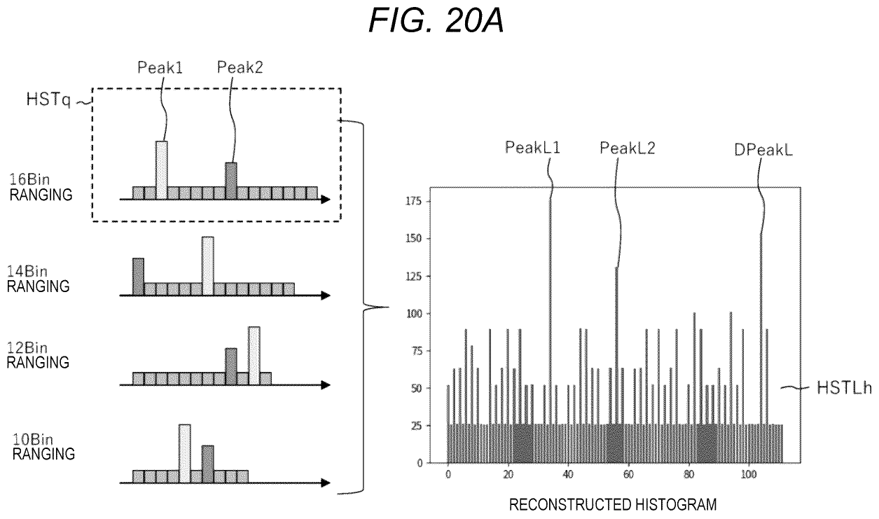

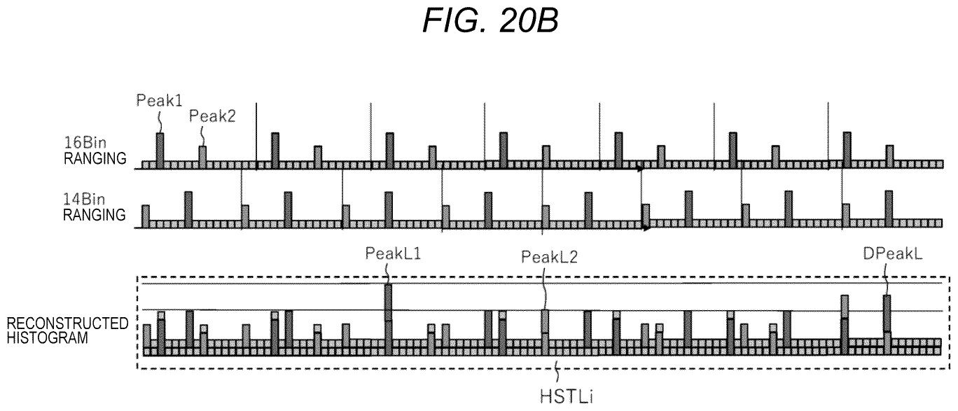

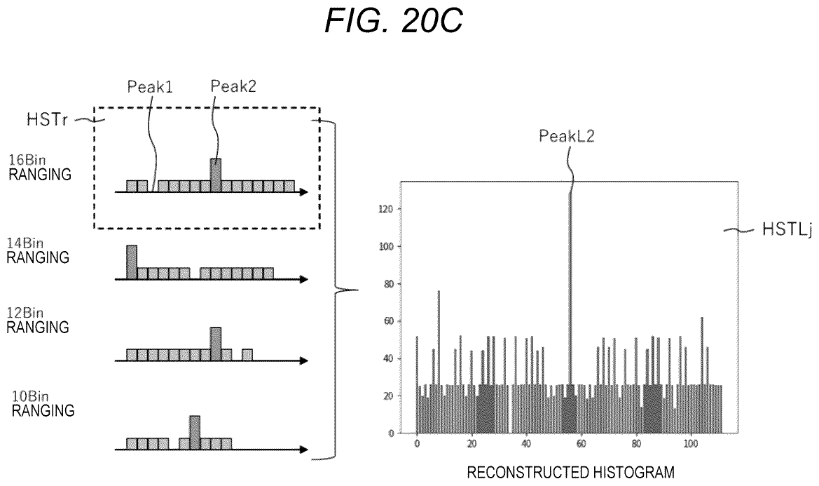

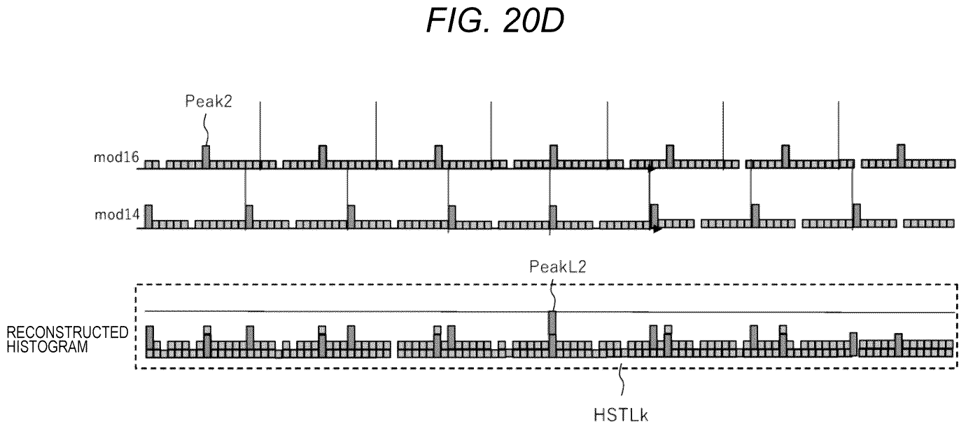

FIG. 20A is a diagram illustrating an example in which a first peak value and a second peak value are detected in 16Bin ranging, 14Bin ranging, 12Bin ranging, and 10Bin ranging, respectively. That is, FIG. 20A illustrates an example in which the reflected light pulse signals L2 from the two objects OBJ are received. As illustrated in FIG. 20A, the histogram HSTq in each ranging has a first peak value Peak1 and a second peak value Peak2. In the reconstructed histogram HSTLh, in addition to the first peak value PeakL1, there is a plurality of bins affected by the first peak value Peak1 in the histogram HSTq (for example, DPeakL).

FIG. 20B is a diagram for explaining the reason why the bins affected by the first peak value Peak1 in FIG. 20A appears. For simplification of description, FIG. 20B illustrates an example in which a reconstructed histogram HSTLi is generated by combining a duplicate histogram obtained by duplicating and tiling a histogram generated by 16Bin ranging and a duplicate histogram obtained by duplicating and tiling a histogram generated by 14Bin ranging. In the reconstructed histogram HSTLi in FIG. 20B, the component of the first peak value Peak1 appears in a plurality of bins. In this case, the second peak value Peak2 may not be correctly detected.

FIG. 20C is a diagram for explaining a processing operation of the ranging device according to the fifth embodiment. In the present embodiment, as illustrated in FIG. 20C, after the detection of the first peak value Peak1, a histogram HSTr in which a component of the first peak value Peak1 is deleted from each of histograms of 16Bin ranging, 14Bin ranging, 12Bin ranging, and 10Bin ranging is generated. By duplicating, tiling, and overlaying these histograms HSTr to generate the reconstructed histogram HSTLj, the second peak value PeakL2 can be detected without being affected by the first peak value Peak1. FIG. 20D is a diagram illustrating an example in which a reconstructed histogram is newly generated after the component of the first peak value Peak is deleted from the duplicate histogram illustrated in FIG. 20B. It can be seen that the second peak value PeakL2 is the peak value of the reconstructed histogram HSTLk as compared with the reconstructed histogram HSTLi in FIG. 20B.

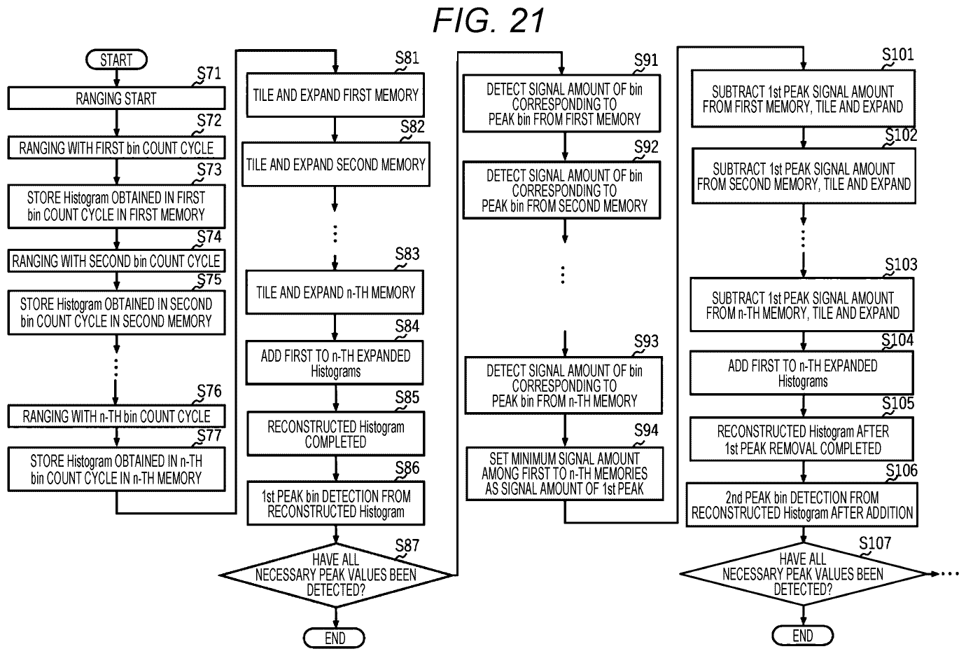

FIG. 21 is a flowchart illustrating processing of the ranging section 44 in the fifth embodiment. In steps S71 to S86 illustrated in FIG. 21, processing for detecting the first peak will be described. In addition, in steps S91 to S106, processing for detecting the second peak will be described.

In step S71, the light emitting device 3 and the like are driven to start the ranging processing. The photodetection device 4 performs ranging (for example, 16Bin ranging) in a first bin count cycle, and stores the histogram generated by the histogram generator 42 in the first memory (region in the SRAM 43) (steps S72 and S73). Similarly, in steps S74 and S75, the histogram generated in the second bin count cycle (for example, 14Bin cycle) is stored in the second memory in the SRAM 43.

This is performed for all the light emission intervals, and in steps S75 and S76, the histogram generated in the n-th bin count cycle is stored in the n-th memory in the SRAM 43.

In steps S81 to S85, processing similar to the processing described in FIG. 11 or FIGS. 13A to 13C is performed. In step S86, a bin of the reconstructed histogram having the first peak is acquired. In step S87, it is determined whether or not to acquire the second peak value, and in a case where the second peak value is acquired, the process proceeds to step S91.

In steps S91 to S94, the signal amount to be deleted when the first peak is deleted is determined from the histogram acquired in step S73 or the like.

In step S91, the bin corresponding to the bin of the reconstructed histogram having the first peak acquired in step S86 is acquired from the histogram stored in the first memory. Further, the signal amount of the bin is acquired.

In steps S92 to S94, processing similar to that in step S91 is performed on each of the histograms acquired in steps S74 to S77. As a result, the signal amount of the bin corresponding to the first peak can be acquired from each histogram. In step S94, the minimum signal amount among the acquired signal amounts is set as the signal amount of the first peak.

In steps S101 to S105, a reconstructed histogram is generated similarly to steps S81 to S85. However, before tiling, the first peak is deleted from the histogram.

Specifically, the processing in step S101 will be described. The signal amount of the first peak acquired in step S94 is subtracted from the signal amount of the bin corresponding to the first peak found in step S91 with respect to the histogram stored in the first memory. Thereafter, processing similar to that in step S81 is performed.

In step S106, the second peak is acquired similarly to step S86. In step S107, it is determined whether or not to acquire the third peak value, and in a case where the third peak value is acquired, the process proceeds to acquisition processing of the third peak value (not illustrated). Also in the process of acquiring the third peak value, similarly to the process of acquiring the second peak value, the process of reducing the signal amount of the bin corresponding to the second peak value from the histogram stored in the first memory or the like is performed.

As described above, in the fifth embodiment, after the first peak value is acquired from the reconstructed histogram, the reconstructed histogram from which the first peak value is deleted is regenerated, so that the true second peak value can be correctly detected without being affected by the first peak value. As a result, the ranging system 1 can perform ranging for a plurality of objects OBJ arranged at different places in one ranging sequence. The fifth embodiment can be applied to any of the first to fourth embodiments.

### Sixth Embodiment

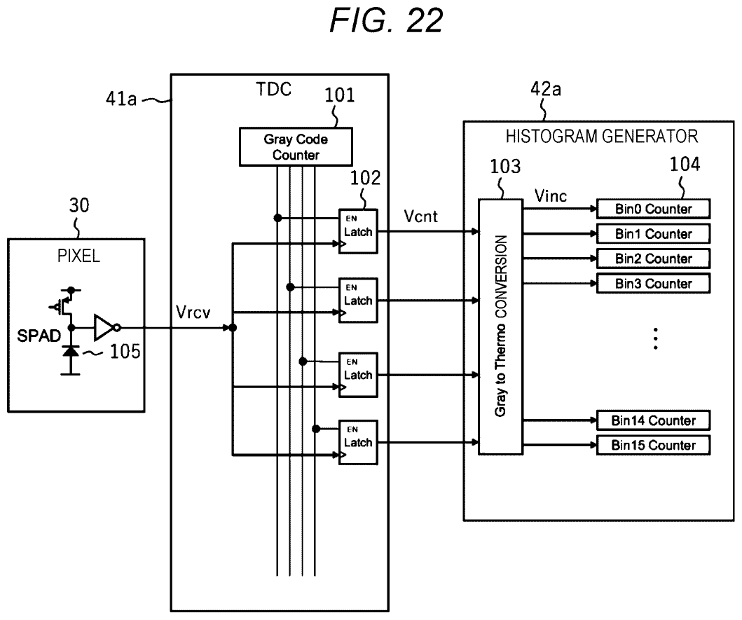

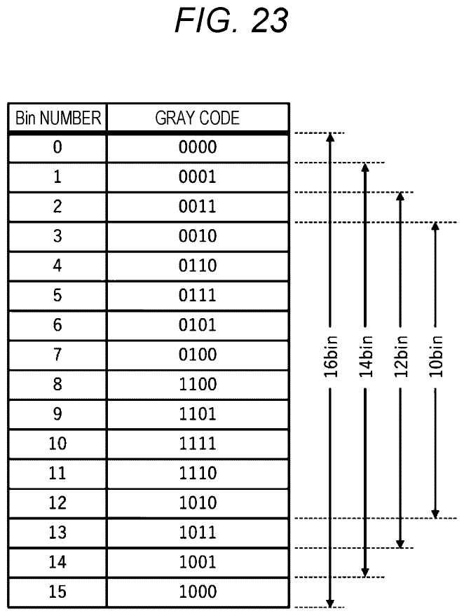

In the time digital converter 41 of the present disclosure, a gray code can be used in order to suppress power fluctuation due to count signal propagation. FIG. 22 is a diagram illustrating a time digital converter 41a and a histogram generator 42a in a sixth embodiment. FIG. 23 is a diagram illustrating gray codes output from a gray code counter to be described later.

The gray code includes a plurality of bits as illustrated in FIG. 23, and only one bit of the plurality of bits transitions. Since each bit of the gray code is connected to a Separate wiring, by using the gray code, it is possible to minimize the bit transition amount when the gray code transitions and to reduce power consumption.

The time digital converter 41a includes a gray code counter 101 and a plurality of latch sections 102. The histogram generator 42a includes a gray to thermo (GT) conversion section 103 and a bin counter 104.

The pixel 30 includes a pixel circuit including a photoelectric conversion element 105 such as a SPAD. The photoelectric conversion element 105 generates a charge corresponding to the received light. The pixel circuit supplies a light reception signal Vrcv corresponding to the charge generated by the photoelectric conversion to the time digital converter 41a.

The gray code counter 101 outputs a 4-bit gray code to the plurality of latch sections 102 as illustrated in FIG. 23, for example, on the basis of the measurement start signal and the clock signal Vclk supplied from the ranging control section 26.

The plurality of latch sections 102 latches the gray code at the timing when the light reception signal Vrcv is supplied from the pixel 30. The latched gray code is supplied to the histogram generator 42a as the digital signal Vcnt.

The GT conversion section 103 in the histogram generator 42a includes a plurality of conversion tables that is different for each cycle of exposure rotation and convert gray codes into light reception time data. The GT conversion section 103 converts the gray code acquired from the latch section 102 using a conversion table corresponding to the cycle of the exposure rotation at that time to acquire the bin number. The GT conversion section 103 supplies the counter increment signal Vinc to the bin counter 104 corresponding to the acquired bin number.

Each bin counter 104 increments the count value when a corresponding counter increment signal Vinc is supplied.

As described above, when a histogram is generated by the histogram generator 42a, it is necessary to perform processing of accumulating the number of light reception data for each bin to generate light reception frequency data, and by using gray codes when the light reception data of each bin is transmitted to the histogram generator 42a, the signal transition amount between the time digital converter 41a and the histogram generator 42a can be reduced, and power consumption can be suppressed.

Since the bin count to be used is different among the 16Bin ranging, the 14Bin ranging, the 12Bin ranging, and the 10Bin ranging, different continuous ranges among the transition ranges of the gray codes of 4 bits are used in each Bin ranging as illustrated in FIG. 23. In the 16Bin ranging, 16 gray codes in the transition range of the Bin number 0 to 15 in FIG. 23 are used. In other Bin ranging, a continuous range of a part of the transition range of the gray codes used by the 16Bin ranging is used, and serial numbers from the Bin number 0 are assigned to the gray codes in the continuous range to be used.

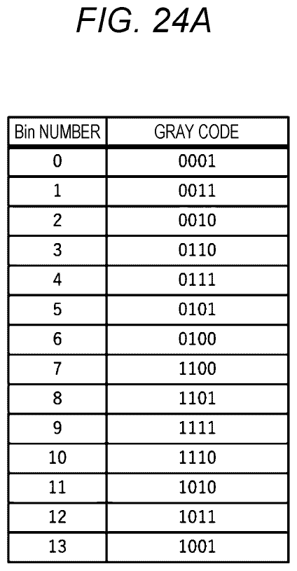

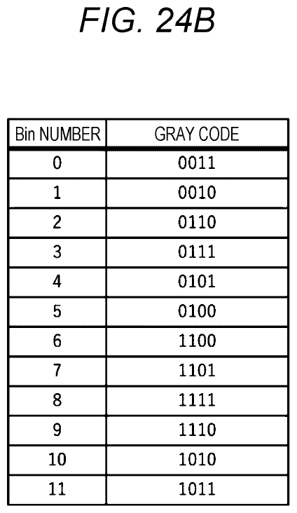

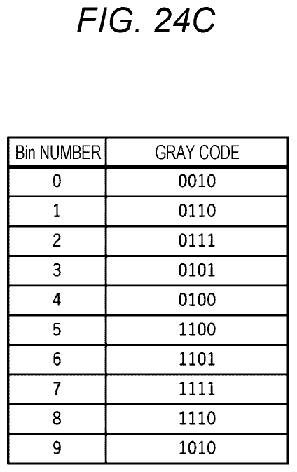

FIG. 24A illustrates a transition range of gray codes corresponding to 14Bin ranging. In the 14Bin ranging, the time digital converter 41a uses a continuous range of the gray codes 0001 to 1001 in FIG. 23 and assigns a Bin number 0 to 13 to this continuous range. Therefore, the conversion table according to the 14Bin ranging included in the GT conversion section 103 in the histogram generator 42a associates the 14 gray codes in FIG. 24A with the 14 bin counters 104 corresponding to the Bin number 0 to 13.

Similarly, FIG. 24B is a diagram illustrating a transition range of gray codes corresponding to 12Bin ranging, and FIG. 24C is a diagram illustrating a transition range of gray codes corresponding to 10Bin ranging. Similarly to the conversion table corresponding to the 14Bin ranging, the conversion table corresponding to the 12Bin ranging or the conversion table corresponding to the 10Bin ranging associates the gray code in FIG. 24B or 24C with 12 or 10 bin counters 104.

As described above, in the sixth embodiment, since the gray code counter 101 is provided in the time digital converter 41a and the GT conversion section 103 is provided in the histogram generator 42a, the signal transition amount of the digital signal for each bin from the time digital converter 41a to the histogram generator 42a can be minimized, the fluctuation of the power supply voltage can be suppressed, and the power consumption can be reduced.

### Seventh Embodiment

In the first to sixth embodiments, a true peak is extracted on the basis of the reconstructed histogram. In addition, in the first to sixth embodiments, two or more duplicate histograms are added for each bin to generate a reconstructed histogram, but the reconstructed histogram may be generated by another method.

As illustrated in FIG. 4D, the true peak is present at a position where all the duplicate histograms have a peak. Meanwhile, the false peak is present at a position where the at least one duplicate histogram has no peak. On the basis of these features, the true peak can be searched.

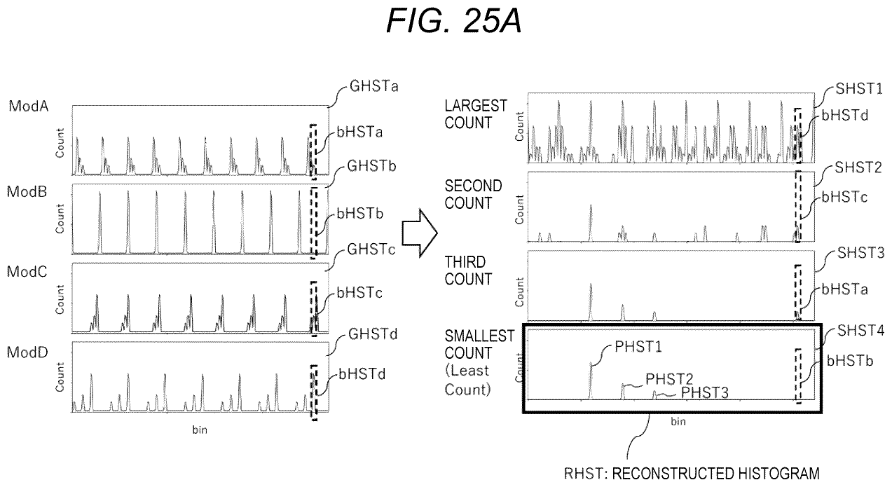

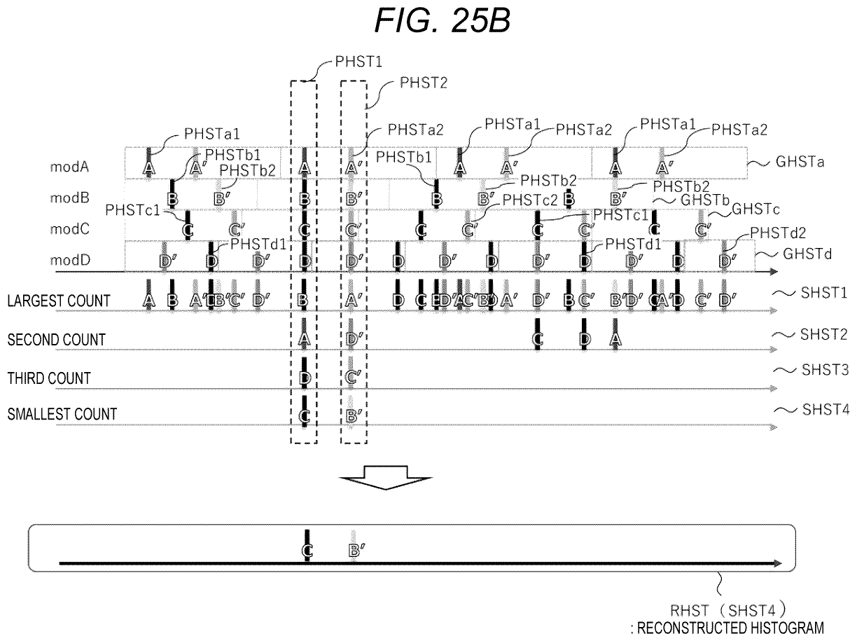

FIG. 25A is a diagram for explaining generation of a reconstructed histogram according to a seventh embodiment. On the left side of FIG. 25A, four duplicate histograms GHSTa, GHSTb, GHSTc, and GHSTd are illustrated. Each of the duplicate histograms GHSTa, GHSTb, GHSTc, and GHSTd is obtained by tiling (duplicating) a plurality of histograms generated by ranging ModA, ModB, ModC, and ModD of four different Bin cycles. As described above, all four duplicate histograms have the same bin count. The horizontal axis of each of the duplicate histograms GHSTa to GHSTd indicates a bin number (Bin), and the vertical axis indicates a count value (Count) for each bin number.

In addition, on the right side of FIG. 25A, count order histograms SHST1, SHST2, SHST3, and SHST4 in which the count values of the respective bins of the four duplicate histograms GHSTa to GHSTd are arranged in order of magnitude are illustrated. The horizontal axis of the count order histograms SHST1 to SHST4 indicates a bin number (Bin), and the vertical axis indicates a count value (Count) for each bin number. The count value of each bin of the duplicate histograms GHSTa to GHSTd is allocated to any one of the count order histograms SHST1 to SHST4 in order of magnitude. That is, the count order histogram SHST1 is generated by collecting the largest count value of each bin, the count order histogram SHST2 is generated by collecting the second largest count value of each bin, the duplicate histogram STST3 is generated by collecting the third largest count value of each bin, and the duplicate histogram STST4 is generated by collecting the smallest count value of each bin.

For example, the duplicate histograms GHSTa, GHSTb, GHSTc, GHSTd respectively include bins bHSTa, bHSTb, bHSTc, bHSTd having the same bin number. Among the bins bHSTa-bHSTd, the bin bHSTd with the largest count value is allocated to the count order histogram SHST1, the bin bHSTc with the second count value is allocated to the count order histogram SHST2, the bin bHSTa with the third count value is allocated to the count order histogram SHST3, and the bin bHSTb with the smallest count value is allocated to the count order histogram SHST4. Since the bin bHSTd is a peak in the duplicate histogram GHSTd, a peak appears in the corresponding bin of the count order histogram SHST1. Meanwhile, since the bin bHSTb is not a peak in the duplicate histogram GHSTb, no peak appears in the corresponding bin of the count order histogram SHTS4.

FIG. 25B is a diagram illustrating a relationship between the duplicate histograms GHSTa to GHSTd and the count order histograms SHST1 to SHST4 illustrated in FIG. 25A. In addition, in the duplicate histograms GHSTa to GHSTd in FIG. 25B, a first peak PHSTa1 (A) of ModA, a first peak PHSTb1 (B) of ModB, a first peak PHSTc1 (C) of ModC, and a first peak PHSTd1 (D) of ModD are illustrated. The first peak is a largest count value in the same bin of the duplicate histograms GHSTa to GHSTd. As described above, a plurality of first peaks PHSTa1 to PHSTd1 may be present in each of the duplicate histograms GHSTa to GHSTd. In addition, FIG. 25B illustrates a true first peak PHST1.

The timing at which the first peaks of all the MODs are aligned is the true first peak. In the present embodiment, a true first peak is detected by using a count order histogram in which peaks appear in all the MODs and the count value of the peak is the smallest as the reconstructed histogram RHST.

Since the bin having the largest count value is allocated to the count order histogram SHST1, many of the first peaks PHSTa1 to PHSTd1 appear on the count order histogram SHST1. In addition, a true peak and a false peak are mixed in the count order histogram SHST1.

In the count order histogram SHST2 to which the bin having the second count value is allocated, if there is no peak having the second count value, no peak appears. Therefore, in the count order histogram SHST2, no peak appears unless at least two peaks are present at the same bin number. Similarly, in the count order histogram SHST3, no peak appears unless at least three peaks are present at the same bin number.

In the count order histogram SHST4, a peak appears only in a case where all the duplicate histograms GHSTa to GHSTd have peaks with the same bin number. That is, a peak appearing in the count order histogram SHST4 illustrated in FIG. 4D is a true peak. Therefore, the reconstructed histogram RHST can be generated on the basis of the count order histogram SHST4 to which the bin having the smallest count value is allocated.

Further, in the duplicate histograms GHSTa, GHSTb, GHSTc, and GHSTd of FIG. 25B, a second peak PHSTa2 (A′) of ModA, a first peak PHSTb2 (B′) of ModB, a first peak PHSTc2 (C′) of ModC, and a first peak PHSTd2 (D′) of ModD are illustrated, respectively. The timing at which the second peaks of all the MODs are aligned is the true second peak. Similarly, the true second peak PHST2 can be detected on the count order histogram SHST4 on the basis of the second peaks PHSTa2, PHSTb2, PHSTc2, and PHSTd2. Note that, as described with reference to FIGS. 20A to 20C, the detection processing of the true second peak PHST2 may be performed in a state where the influence of the first peaks PHSTa1 to PHSTd4 is removed in advance from the duplicate histograms GHSTa to GHSTd.

Note that, in the reconstructed histogram RHST, the count value of the true first peak is larger than the count value of the true second peak.

As described in FIG. 25B, in the seventh embodiment, the same bin in which each of the two or more duplicate histograms GHSTa to GHSTd has the peak value of the light reception frequency is searched, and the reconstructed histogram RHST is generated on the basis of the smallest count value (peak value) in the searched bin. In the present specification, a scheme of generating the reconstructed histogram RHST with the smallest count value as described above is referred to as a least count pickup (LCP) scheme. In addition, in the first to sixth embodiments, a scheme of adding two or more duplicate histograms for each bin to generate a reconstructed histogram is referred to as an addition scheme.

Compared with the reconstructed histogram HSTLa in FIG. 6, since the influence of the false peak is removed from the reconstructed histogram RHST in FIG. 25A, the true peak (true first peak PHST1, true second peak PHST2, and true third peak PHST3) can be accurately detected.

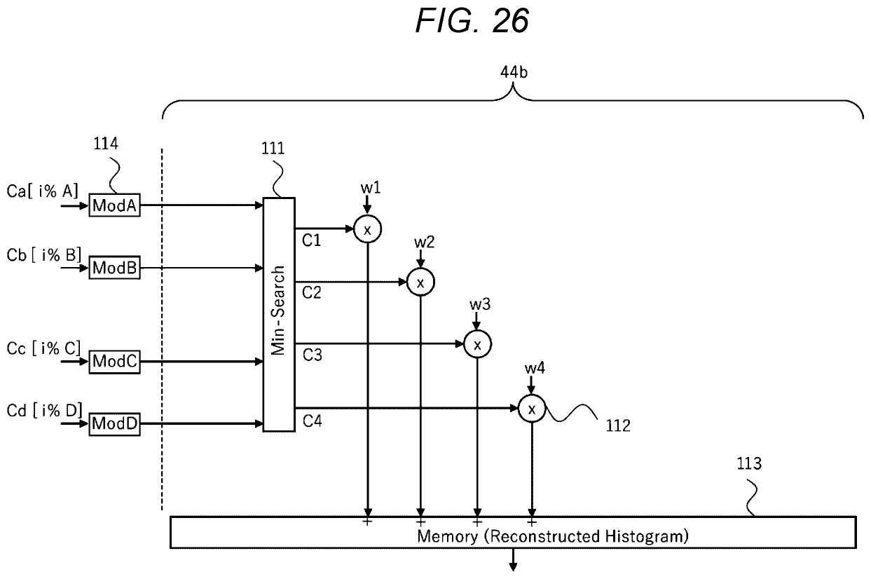

FIG. 26 is a block diagram illustrating a configuration of a ranging section 44b according to the seventh embodiment. The ranging section 44b includes a minimum search section (min-search) 111, a plurality of weighting sections 112, and a memory section 113. The minimum search section 111 and the plurality of weighting sections 112 are arranged, for example, in the duplicate histogram generator 45. The memory section 113 is disposed in the SRAM 46, for example.

The ranging section 44b inputs data of each bin from the plurality of memory sections 114. The plurality of memory sections 114 is memories that store data of each bin generated by ranging of different Bin cycles, and are arranged, for example, in the SRAM 43. In the example of FIG. 26, four memory sections 114 corresponding to ModA to ModD are included. The memory section 114 corresponding to Moda stores, for example, a count value Ca [i%A] based on a remainder obtained by dividing the count code i of the time digital converter 41 by the Bin count A. Similarly, the count values Cb [i&B], Cc [i&C], and Cd [i&D] are stored in the memory sections 114 corresponding to ModB, ModC, and ModD.

The minimum search section 111 sorts the data of each bin by the count value and sorts the data into the count signals C1, C2, C3, and C4 in descending order of the count value. Count signals C1 to C4 are input to the plurality of (four in the example of FIG. 26) weighting sections 112, respectively. Further, weighting coefficients w1, w2, w3, and w4 for multiplying the count signals C1, C2, C3, and C4 are input to the weighting sections 112. The memory sections 113 store the weighted count signals C1 to C4 in the weighting section 112.

In the case of adopting the LCP scheme described above, the weighting coefficients are set to, for example, w1=w2=w3 =0 and w4=1. As a result, the count values included in the count signals C1 to C3 are ignored, and the reconstructed histogram (for example, the reconstructed histogram RHST in FIG. 25B) is generated on the basis of the count signal C4. Note that the ranging section 44b may generate the reconstructed histogram by reflecting the information of the count values of the count signals C1 to C3 by adjusting the weighting coefficient. The scheme of generating the reconstructed histogram on the basis of the count value weighted according to the order of magnitude is also called an expanded LCP scheme. Alternatively, the ranging section 44b may omit the weighting section 112 and directly input count signal C4 extracted by the minimum search section 111 to the memory section 113.

As described above, in the seventh embodiment, in a case where a peak appears in the same bin of a plurality of duplicate histograms, the reconstructed histogram is generated on the basis of the duplicate histogram having the smallest count value among the plurality of duplicate histograms. Therefore, since a true peak can be detected with a small count value, the circuit scale of the counter can be reduced, and the possibility of erroneous detection of a false peak can be avoided. The LCP scheme described in the seventh embodiment can be applied to any of the first to sixth embodiments.

### Eighth Embodiment

The ranging system 1 of the present disclosure is based on the premise that the ranging processing is performed by detecting a peak of a histogram generated by repeatedly receiving reflected light emitted from a specific light emitting device and reflected by an object. However, there is a possibility that light from an unknown light emitting body other than the specific light emitting device is directly received, or reflected light obtained by reflecting the light by the object is received. Since received light caused by light from an unknown light emitting body is interference light and may adversely affect ranging accuracy, it is necessary to suppress the influence of the interference light.

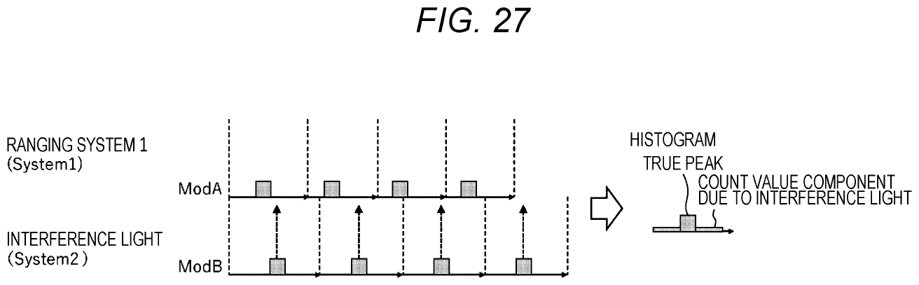

FIG. 27 is a diagram for explaining a method of suppressing an influence of interference light of a ranging system 1 according to an eighth embodiment. As described above, the ranging system 1 of the present disclosure measures the distance to the ranging target object on the basis of the peak of the histogram generated by repeatedly receiving the reflected light pulse signal having periodicity. Therefore, interference light having no periodicity does not generate a peak and does not affect ranging. In addition, even in a case where the interference light has periodicity, as illustrated in FIG. 27, in a case where the light emission cycle of the ranging system 1 is different from the light emission cycle of the interference light, the count value component due to the interference light is dispersed over the entire histogram. As a result, the peak due to the interference light becomes sufficiently smaller than the true peak, and thus the ranging is not affected.

Therefore, interference light having the same light emission cycle as the light emission cycle of the ranging system 1 of the present disclosure is assumed as interference light that may affect ranging. More specifically, when there are two or more ranging systems 1 of the present disclosure, it is assumed that they affect each other. FIG. 27 illustrates an example in which the ranging system 1 (System_1) according to the eighth embodiment of the present disclosure performs ranging in a light emission cycle different from a light emission cycle of another ranging system (System 2). More specifically, when System_2 performs ranging of ModB, System_1 performs ranging of ModA having a different Bin cycle from ModB. As a result, System_1 can suppress the influence of the interference light received from System_2, and can also suppress the influence of the interference light from System_1 to Sysem2. Note that, in the present specification, the Bin cycle may be referred to as MOD.

The ranging system 1 according to the eighth embodiment includes an interference suppression section 120 that suppresses the influence of the interference light described above. The interference suppression section 120 is built in, for example, the control section 22 in FIG. 1. Alternatively, it may be provided separately from the control section 22.

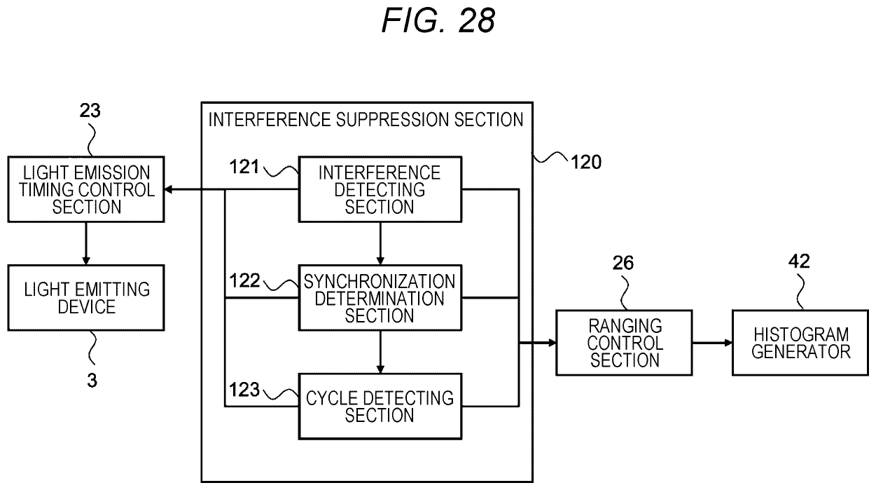

FIG. 28 is a block diagram illustrating the interference suppression section 120 according to the eighth embodiment. The interference suppression section 120 includes an interference detecting section 121, a synchronization determination section 122, and a cycle detecting section 123. The interference detecting section 121 detects the presence or absence of interference by an unknown light pulse signal (that is, the interference light of FIG. 27). When interference is detected by the interference detecting section 121, the synchronization determination section 122 determines whether or not synchronization can be performed with the cycle switching of the interference light. The cycle detecting section 123 detects a switching order of a plurality of cycles of the interference light. The interference detecting section 121, the synchronization determination section 122, and the cycle detecting section 123 cause the histogram generator 42 to generate a histogram for detecting interference light.

In addition, the interference detecting section 121, the synchronization determination section 122, and the cycle detecting section 123 cause the light emission timing control section 23 to control the light emission timing of the light emitting device 3 in order to avoid the influence of the interference light. As described with reference to FIG. 27, the light emission timing control section 23 causes the light emitting device 3 to repeatedly emit light at a light emission cycle different from the light emission cycle of the interference light, that is, at a time interval different from a plurality of time intervals of the interference light. Alternatively, the light emission timing control section 23 causes the light emitting device 3 to repeatedly emit light in a sequence (that is, switching order of cycle) different from the sequence (switching order of cycle) of the plurality of time intervals of the interference light.

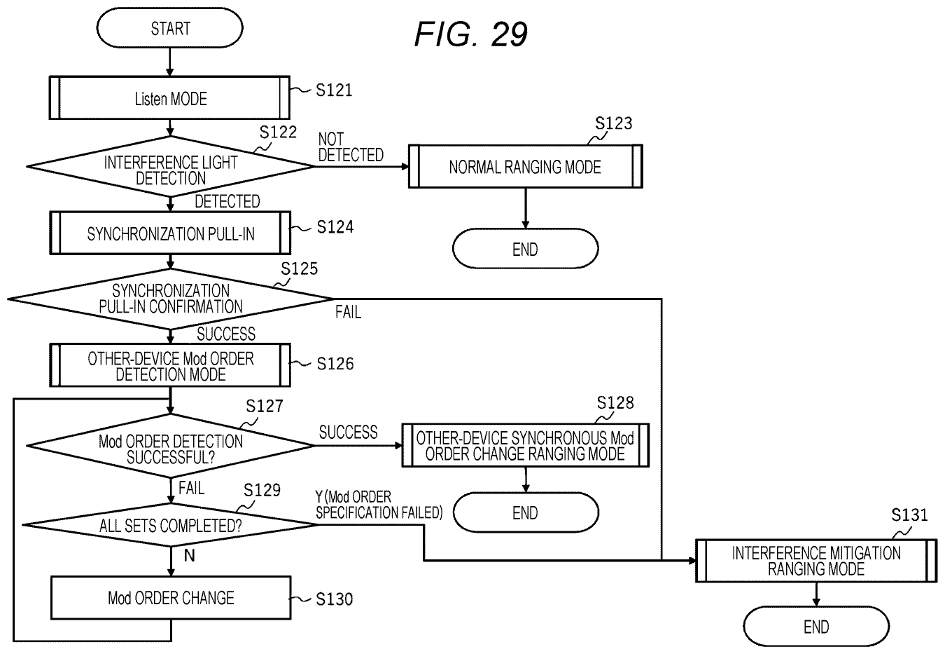

FIG. 29 is a flowchart for implementing the interference light suppression method according to the eighth embodiment. First, the ranging system 1 according to the eighth embodiment is set to the Listen mode before starting ranging (step S121). In the Listen mode, light emission by the light emitting device 3 is stopped, and the photodetection device 4 performs light receiving processing to detect an unknown light pulse signal (that is, interference light). In step S121, for example, the interference detecting section 121 in FIG. 28 causes the light emission timing control section 23 to stop light emission of the light emitting device 3 and causes the ranging control section 26 to monitor the presence or absence of interference light.

The interference detecting section 121 determines the presence or absence of interference light (step S122). Here, the interference light is light received periodically as described above, and received light having no periodicity is not regarded as the interference light. In a case where no interference light is detected, the ranging system 1 is set to the normal ranging mode (step S123). Specifically, the light emitting device 3 starts light emission, and the photodetection device 4 performs normal multi-frequency ranging. The normal multi-frequency ranging is ranging according to any one of the first to seventh embodiments.

In a case where the interference light is detected in step S122, synchronization pull-in is performed (step S124). Synchronization pull-in refers to a process of specifying a cycle of interference light. The synchronization determination section 122 attempts to synchronize the cycle of the specific MOD of the ranging system 1 with any cycle of the interference light. If any cycle of the interference light is the same as the cycle of the specific MOD of the ranging system 1, synchronization can be performed by aligning the phases of the interference light. The synchronization determination section 122 determines whether the synchronization pull-in is successful (step S125).

In a case where the synchronization pull-in is successful in step S125, further analysis of the interference light is performed on the basis of this. In a case where the interference light sequentially switches the plurality of cycles, the cycle detecting section 123 detects the switching order (step S126). This process is performed to detect whether or not the interference light is performing ranging by switching a plurality of cycles in a switching order similar to that of the ranging system according to the present disclosure. This process is also referred to as an other-device MOD order detection mode since the switching order (hereinafter, MOD order) of the MOD of other devices is detected.

In the other-device MOD order detection mode, the interference suppression section 120 detects the MOD order of other devices by confirming the degree of interference while changing the MOD order of the ranging system 1. First, based on the MOD order set in step S126, it is determined whether or not the cycle detecting section 123 has successfully detected the MOD order of other devices (step S127).

In a case where the cycle detecting section 123 succeeds in detecting the MOD order of other devices, the interference suppression section 120 changes the MOD order of the ranging system 1 on the basis of the MOD order of the other devices (step S128). Here, the MOD order of the ranging system 1 is changed so as to be different from the MOD order of the other devices. The influence of the interference light can be avoided by making the MOD order of the ranging system 1 different from the MOD order of other devices.

The ranging mode in step S128 is also referred to as an other-device synchronous MOD order change ranging mode.

In a case where the cycle detecting section 123 fails to detect the MOD orders of other devices in step S127, the interference suppression section 120 determines whether the other-device MOD order has been detected in all the MOD orders (step S129). In a case where there is the MOD order in which the other-device MOD order has not been detected yet, the interference suppression section 120 changes the MOD order of the ranging system 1 to the MOD order in which the other-device MOD order has not been detected yet (step S130). As a result, the cycle detecting section 123 detects the other-device MOD order again, and the determination in step S127 is performed.

Steps S127 to S130 are repeated until the detection in the MOD orders of other devices succeeds or the detection in the other-device MOD orders fails in all the MODS. In a case where it is determined in step S129 that the detection in the other-device MOD order has been performed in all the MOD orders, it is regarded that the specification of the other-device MOD order has failed.

In a case where synchronization pull-in has failed in step S125 or in a case where specification of the other-device MOD order has failed, the synchronization determination section 122 determines that synchronization with other devices is impossible. As a result, the ranging system 1 performs ranging in the interference mitigation ranging mode. Specifically, the ranging system 1 performs ranging by randomizing the MOD order and the MOD switching interval, thereby mitigating interference with ranging from other devices.

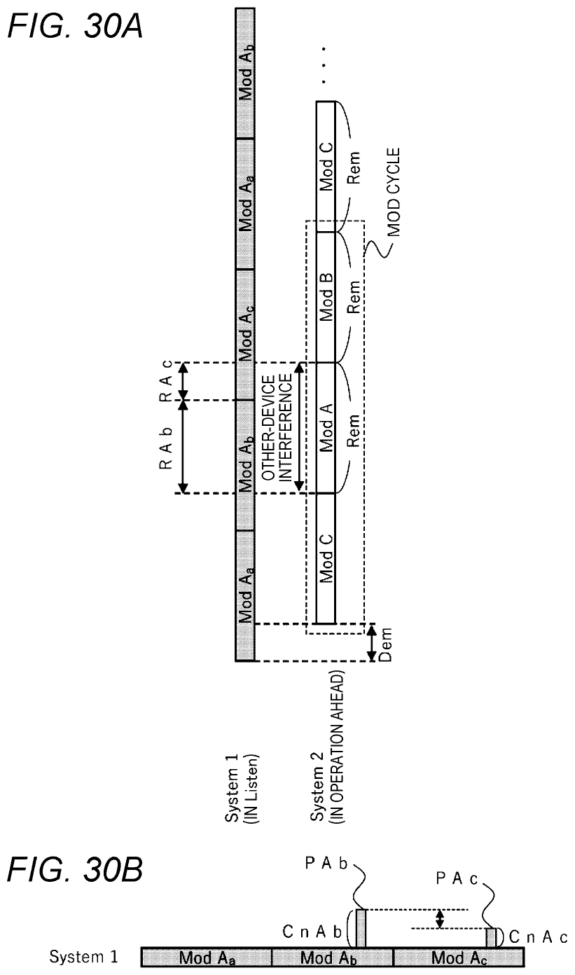

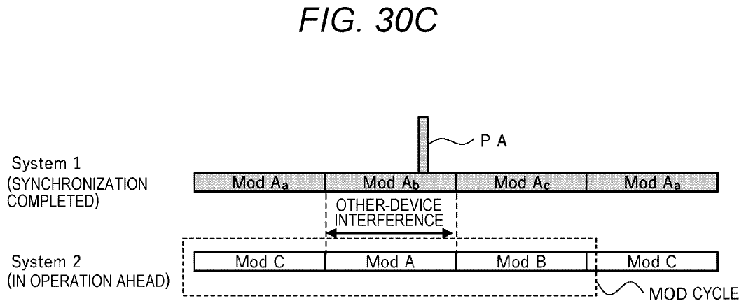

FIGS. 30A and 30B are diagrams for explaining details of the Listen mode executed in step S121 of FIG. 29. FIG. 30C is a diagram for explaining details of the synchronization pull-in executed in step S124 of FIG. 29. FIGS. 30A to 30C illustrate cycle switching timing between the ranging system 1 (System_1) according to the eighth embodiment of the present disclosure and the cycle of another ranging system (System_2). System_1 and System_2 perform ranging while switching between ModA, ModB, and ModC having different Bin cycles (that is, PRI is also different). It is assumed that ModA, ModB, and ModC have a long Bin cycle (and PRI) in this order. Note that, in the present specification, a series of ranging periods including one each of ModA to ModC is also referred to as a MOD cycle.

Further, in System_1 (and System_2), the MOD cycles (exposure periods) Rem of ModA to ModC are the same. As a result, in synchronization pull-in described later, the MOD switching timing can be synchronized between System_1 and System_2. Note that since one PRI is shorter in ModC than in ModA, the number of PRIs increases. The influence of the difference in the number of PRIs can be corrected by, for example, weighting of the count value.

In FIG. 30A, before starting ranging, System_1 is set to the Listen mode in step S121. In the Listen mode, while the light emission of the light emitting device 3 is stopped, the System_1 detects interference light using any one of a plurality of Bin cycles. In the Listen mode, a histogram is generated by repeatedly using any one of the MOD cycles. In the example of FIG. 30A, System_1 detects interference light with ModAa, ModAb, and ModAc having the same Bin cycle as ModA. ModAa, ModAb, and ModAc each independently accumulate count values, and each independently generate a histogram. In FIG. 30A, System_2 is performing normal multi-frequency ranging ahead. Therefore, in ModAa to ModAc, histograms are generated on the basis of interference light from System_2.

In the Listen mode, System_1 may detect interference light in the same Bin cycle as ModB or ModC instead of ModA. Note that, in order to reduce exposure waste and a synchronization error, it is efficient to perform the interference light detection operation in a Bin cycle (that is, in FIG. 30A, the Bin cycle of ModA) having the longest Bin cycle and a small number of PRIs.

As illustrated in FIG. 30A, a period during which System_2emits light of ModA is a period during which System_1 and System_2 have the same Bin cycle and receive interference (hereinafter, other-device interference period). In the example of FIG. 30A, the period RAb in ModAb and the period RAc in ModAc are the other-device interference periods. There is no other-device interference period in ModAa.

The sum of the periods RAb and RAc matches the exposure period Rem of ModA of System_2. The MOD switching cycle of System_1 differs from the MOD switching cycle of System_2 by the interval Dem. How much period of the exposure period Rem is allocated to the period RAb (alternatively, the period RAc) changes according to the length of the interval Dem. Note that the interval Dem is the same length as the period RAc as illustrated in FIG. 30A.

FIG. 30B is a diagram illustrating peaks of histograms generated in ModAa to ModAc. In the ModAb and ModAc having the other-device interference period, the peak PAb and the peak PAc occur. In the ModAa without the other-device interference period, no peak occurs.

In the Listen mode, as illustrated in step S122 of FIG. 29, the presence or absence of interference light is detected based on whether or not a plurality of histograms generated by a plurality of MODs has a peak. In a case where none of the plurality of histograms generated in the Listen mode has a peak, it is found that there is no other-device interference period, that is, there is no interference light. In this case, as illustrated in step S123 of FIG. 29, the ranging system 1 is set to the normal ranging mode. In addition, in a case where even one of the plurality of histograms has a peak, it can be detected that there is interference light.

In FIG. 30B, the peaks PAb and PAc enable System_1 to detect that there is interference light having the same light emission cycle as the Bin cycle of ModA.

As illustrated in step S124 in FIG. 29, in a case where it is detected that there is interference light, System_1 performs synchronization pull-in on the basis of the histogram in FIG. 30B. System_1 detects a shift of the cycle switching timing from the interference light from a plurality of peaks generated in the Listen mode, and synchronizes the cycle switching timing with the interference light on the basis of the detected shift.

The peaks PAb and PAc illustrated in FIG. 30B have count values (hereinafter, the peak count value) CnAb and CnAc corresponding to the lengths of the other-device interference periods RAb and RAc, respectively. System_1 can detect other-device interference periods RAb and RAc from the difference between the peak count values CnAb and CnAc, and can detect an interval Dem that is a shift in cycle switching timing from the interference light.

FIG. 30C is a diagram illustrating synchronization pull-in. As illustrated in step S125 of FIG. 29, in order to confirm whether the synchronization pull-in is successful, similarly to the Listen mode, the System_1 detects interference light of a plurality of MOD cycles and generates a plurality of histograms. In a case where synchronization pull-in is successful, only one of the plurality of MOD cycles has an other-device interference period and only one of the plurality of histograms has a peak. In the example of FIG. 30C, among ModAa to ModAc, only ModAb has the other-device interference period, and only ModAb has the peak PA in the histogram. In addition, the peak PA has a peak count value corresponding to the exposure period Rem.

In a case where two or more histograms of the plurality of histograms have a peak, the synchronization pull-in is failed.

In a case where the synchronization pull-in fails, System_1performs ranging in an interference mitigation ranging mode to be described later. Note that System_1 may determine whether the synchronization pull-in is successful based on whether or not the peak detected after the synchronization pull-in has a peak count value equal to or larger than a predetermined threshold value corresponding to the exposure period Rem.

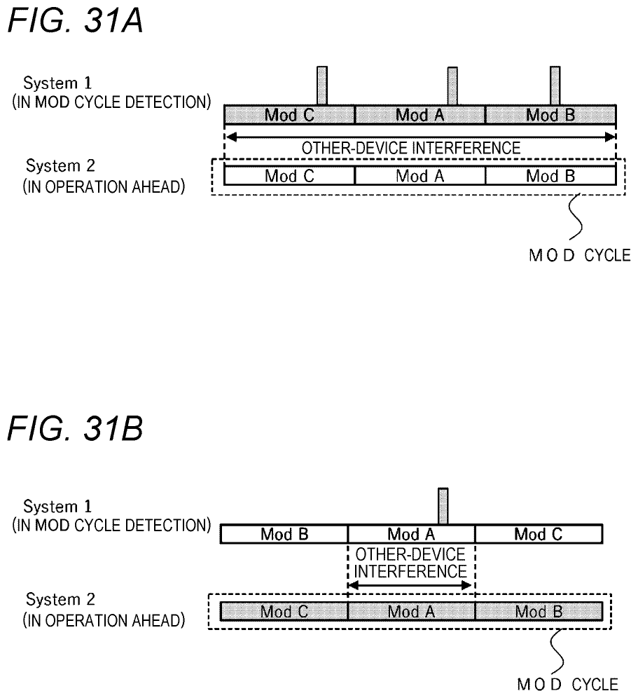

FIGS. 31A and 31B are diagrams for explaining the other-device MOD order detection mode as illustrated in steps S126 and S127 of FIG. 29. System_1 detects interference light by ModA to ModC while the light emission of the light emitting device 3 is stopped. In addition, System_1 variously rearranges the order of ModA to ModC, and generates a histogram for each of ModA to ModC. When the specific MOD order rearranged by System 1 matches the MOD order of System_2, a peak is detected in any of the three histograms corresponding to each MOD cycle as illustrated in FIG. 31A. That is, the MOD order of System_1 in a case where a peak is detected in each of the three histograms is the same as the MOD order of System_2. As a result, in the other-device MOD order detection mode, the MOD order of System_2 can be easily detected.

FIG. 31B is a diagram illustrating a failure example of the other-device MOD order detection mode. FIG. 31B illustrates an example in which System_1 and System_2 have different MOD orders. More specifically, among ModA to ModC, the order of ModA is the same, but the order of ModB and ModC is different. As a result, only ModA has the other-device interference period, and a peak appears in the histogram only in ModA. In a case where there is even one histogram having no peak among the plurality of histograms, System_1 changes the MOD order and again detects interference light and generates a plurality of histograms as illustrated in step S130 of FIG. 29.

Note that System_1 may randomly change the MOD order, or may change the MOD order only for MOD in which no peak appears in the histogram (in FIG. 31B, ModB and ModC are illustrated). In addition, System_1 may specify the order of ModA in advance by confirming the peak of synchronization pull-in in FIG. 30C. For example, in FIG. 30C, ModA can be specified as being at the position of ModAb.

System_1 repeats the change of the MOD order and the detection of the peak of the histogram in each MOD cycle. In a case where the success of the other-device MOD order detection as illustrated in FIG. 31A cannot be confirmed in all the combinations of the MOD orders, as illustrated in step S129 of FIG. 29, Sysytem_1 determines that the other-device MOD order detection has failed. In this case, System_1 performs ranging in the interference mitigation ranging mode.

As described above, by using the histogram generated by the histogram generator 42 in a state where the light emitting device 3 is not emitting light, the ranging system 1 can detect the presence or absence of interference light, perform synchronization pull-in, and detect the MOD order of other devices.

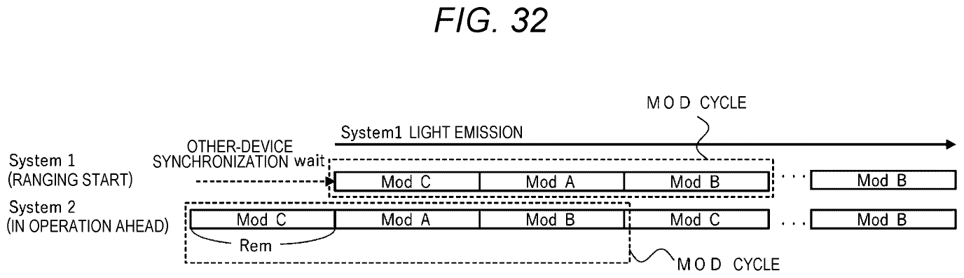

FIG. 32 is a diagram illustrating the other-device synchronous MOD order change ranging mode illustrated in step S128 of FIG. 29. When the MOD order of System_2 is detected by the other-device MOD order detection mode as illustrated in FIG. 31A, System_1 shifts the MOD order of System_2 and applies it to System_1 as illustrated in FIG. 32. Specifically, as illustrated in FIG. 32, System_1 causes the light emitting device 3 to emit light using the MOD order in which the MOD order of System_2 is shifted by one MOD cycle.

Note that, in a case where the MOD order having no peak in all of ModA to ModC (that is, the MOD order is different from the MOD order of other devices) is detected in the other-device MOD order detection mode, System_1 may cause the light emitting device 3 to emit light using the MOD order. As described above, the ranging system 1 performs the multi-frequency ranging in the MOD order obtained by temporally shifting the MOD order of the other device detected by the cycle detecting section 123 or in the MOD order different from the MOD order of the detected other device.

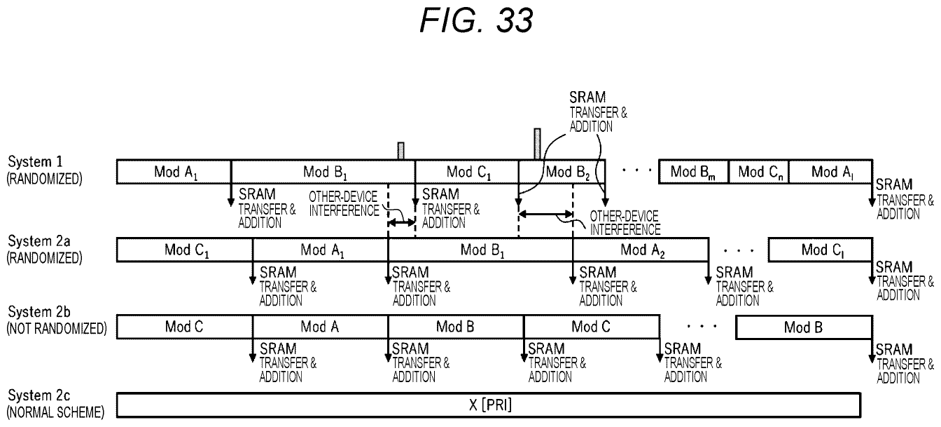

FIG. 33 is a diagram illustrating the interference mitigation ranging mode (step S131 in FIG. 29). In a case where the synchronization pull-in or the other-device MOD order detection fails, if a plurality of MOD cycles in System_1 is used as it is, there is a possibility that the influence of the interference with System_2 is not small.

In this case, System_1 randomly performs ranging without fixing the MOD order and the MOD cycle. As a result, System_1 finely disperses the other-device interference period and mitigates the other-device interference. In the example of FIG. 33, System_1 performs ranging while randomly switching among ModA₁ to ModA₁ in which MOD cycles are randomized by ModA, ModB₁ to ModBₘ in which MOD cycles are randomized by ModB, and ModC₁ to ModCₙ in which MOD cycles are randomized by ModC. In addition, ModA₁ to ModA₁, ModB1 to ModBₘ, and ModC₁ to ModCₙ have random exposure periods and the number of PRIs, respectively.

Note that, in the interference mitigation ranging mode, the total number of PRIs is set to be the same so that there is no difference in the total number of light reception frequencies of the histograms generated by ModA to ModC. Specifically, the sum of the number H PRIs of ModA₁ to ModA₁, the sum of the number of PRIs of ModB₁ to ModBₘ, and the sum of the number of PRIs of ModC₁ to ModCₙ are all adjusted to be the same.

In the interference mitigation ranging mode, the light emission timing control section 23 controls the light emission timing of the light emitting device 3 so that interference with interference light is mitigated. As described above, the light emitting device 3 randomizes the light emission periods of the plurality of light pulse signals so that the total number of light pulse signals used to generate the plurality of histograms becomes equal.

Similarly to System_1, the interference mitigation ranging mode can mitigate interference to ranging of System_1 for any of System_2a that performs multi-frequency ranging in a random MOD order and at MOD switching intervals, System_2b that performs multi-frequency ranging in a uniform Mod order and at Mod switching intervals, and System_2c that performs normal ranging in a single Bin cycle X.

As described above, in the ranging system 1 according to the eighth embodiment of the present disclosure, first, the interference light is repeatedly received in a state of being set to a specific MOD cycle, and whether or not the interference light has the specific MOD cycle is detected. In a case where the interference light has a specific MOD cycle, the synchronization pull-in is performed, and then the switching order of the plurality of MOD cycles in the interference light is detected. When the switching order of the plurality of MOD cycles in the interference light can be detected, the MOD cycle is switched to a MOD cycle different from that of the interference light, and the ranging processing similar to that of the first to seventh embodiments is performed. As a result, similarly to the ranging system according to the present disclosure, even under an environment where interference light for switching a plurality of MOD cycles is received, it is possible to perform highly accurate ranging processing without being affected by the interference light.

### Application Example

The technology according to the present disclosure can be applied to various products. For example, the technology according to the present disclosure may also be implemented as a device mounted on any kind of mobile body such as an automobile, an electric vehicle, a hybrid electric vehicle, a motorcycle, a bicycle, a personal mobility, an airplane, a drone, a ship, a robot, a construction machine, an agricultural machine (tractor), or the like.

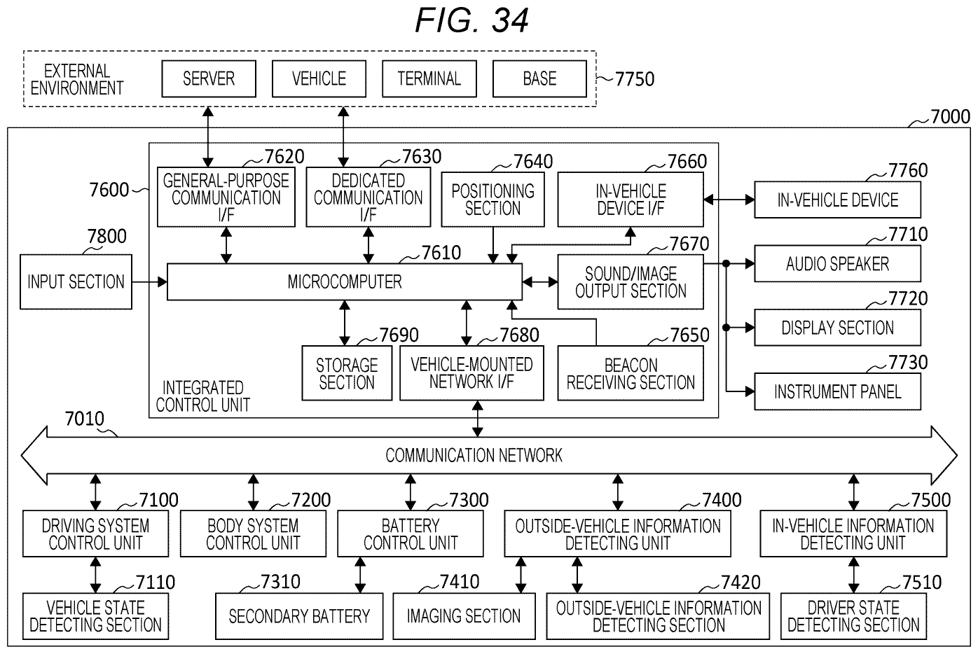

FIG. 34 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 34, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 34 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

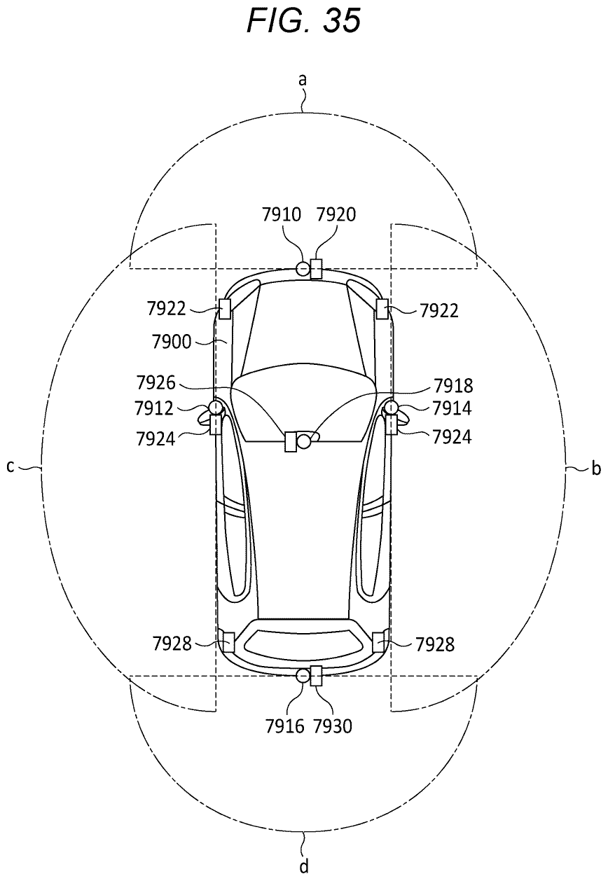

FIG. 35 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 35 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 34, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 34, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 34 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing each function of the ranging section 44 according to the present embodiment can be implemented on any control unit or the like. Furthermore, a computer-readable recording medium in which such a computer program is stored can be provided. The recording medium is, for example, a magnetic disk, an optical disk, a magneto-optical disk, a flash memory, or the like. Furthermore, the computer program described above may be distributed via, for example, a network without using a recording medium.

In addition, at least some of the components of the ranging system 1 described with reference to FIG. 1 and the like may be implemented in a module (for example, an integrated circuit module including one die) for the integrated control unit 7600 illustrated in FIG. 34.

Note that the present technology may have the following configurations.

(1) A photodetection device including:
a light receiving section that receives, within a first time range, a first reflected light pulse signal in which a first light pulse signal emitted at a first time interval is reflected by an object, and receives, within a second time range different from the first time range, a second reflected light pulse signal in which a second light pulse signal emitted at a second time interval different from the first time interval is reflected by the object; and
a histogram generator that generates a first histogram in which a light reception frequency of the first reflected light pulse signal received within the first time range is classified for each predetermined fixed unit period, and generates a second histogram in which a light reception frequency of the second reflected light pulse signal received within the second time range is classified for each unit period.

(2) The photodetection device according to (1), further including
a duplicate histogram generator that generates a first duplicate histogram obtained by duplicating the first histogram by a first number corresponding to the first time interval and generates a second duplicate histogram obtained by duplicating the second histogram by a second number corresponding to the second time interval.

(3) The photodetection device according to (2),
in which the light receiving section receives, within two or more different time ranges, two or more reflected light pulse signals in which two or more light pulse signals emitted at two or more time intervals including the first time interval and the second time interval different from each other are reflected by the object,
the histogram generator generates two or more histograms obtained by classifying light reception frequencies of the two or more reflected light pulse signals received within the two or more time ranges for each unit period,
the duplicate histogram generator generates two or more duplicate histograms obtained by duplicating each of the two or more histograms by a number corresponding to the time intervals corresponding,
the two or more histograms generated by the histogram generator include the first histogram and the second histogram, and
the two or more duplicate histograms generated by the duplicate histogram generator include the first duplicate histogram and the second duplicate histogram.

(4) The photodetection device according to (3),
in which the light receiving section includes a plurality of pixels arranged in two or more in each of a first direction and a second direction, and
each of the plurality of pixels receives the two or more reflected light pulse signals within the two or more time ranges.

(5) The photodetection device according to (4), further including
a packet generator that generates ranging data including the two or more histograms in units of frames,
in which the ranging data includes a start section, a plurality of packets, and an end section,
the start section includes an identifier indicating a head of a frame and a number of the two or more time intervals,
the packet includes a header including a bin count of a histogram corresponding and a number of the plurality of pixels in the two or more histograms, histogram data constituting the histogram corresponding, and a footer including end information of the histogram corresponding, and
the end section includes an identifier indicating an end of the frame.

(6) The photodetection device according to (4), further including
a packet generator that generates ranging data including the two or more histograms in units of frames,
in which the ranging data includes a start section, a plurality of packets, and an end section,
the start section includes an identifier indicating a head of a frame, a number of the plurality of pixels, and a number of the two or more time intervals,
the packet includes a header including information indicating a pixel position, histogram data constituting the histogram corresponding among the two or more histograms, and a footer including end information of the histogram corresponding, and
the end section includes an identifier indicating an end of the frame.

(7) The photodetection device according to any one of (4) to (6), further including
a ranging section that measures a distance of the object on the basis of a light reception time in a case where light reception times corresponding to peak positions of the two or more duplicate histograms including the first duplicate histogram and the second duplicate histogram match each other or a light reception time corresponding to a maximum peak position of a reconstructed histogram synthesized by aligning bin counts of the two or more duplicate histograms.

(8) The photodetection device according to (7),
in which the ranging section adds the two or more duplicate histograms for each bin to generate the reconstructed histogram.

(9) The photodetection device according to (7),
in which each of the two or more duplicate histograms has same bin count, and
the ranging section searches for a same bin in which each of the two or more duplicate histograms has a peak value of a light reception frequency, and generates the reconstructed histogram on the basis of a minimum peak value in the bin searched.

(10) The photodetection device according to any one of (4) to (9), further including
a plurality of time digital converters and a plurality of the histogram generator arranged for each first pixel group including two or more of the pixels arranged in the first direction,
in which each of the plurality of time digital converters sequentially generates a digital signal according to a reception time of the two or more reflected light pulse signals received by each pixel in the first pixel group corresponding, and
each of the plurality of the histogram generator generates the two or more histograms on the basis of the digital signal sequentially generated by the time digital converter corresponding.

(11) The photodetection device according to (10),
in which a plurality of second pixel groups each including two or more of the pixels arranged in the second direction is arranged in the first direction, and
the plurality of the second pixel groups is sequentially selected, and each pixel in the second pixel group selected inputs light reception signals corresponding to the two or more reflected light pulse signals to the plurality of time digital converters in parallel.

(12) The photodetection device according to (11),
in which each pixel in the second pixel group selected sequentially outputs two or more light reception signals according to the two or more reflected light pulse signals in one frame period, and the light reception signals output of the respective pixels in the second pixel group are input to the plurality of time digital converters in parallel.

(13) The photodetection device according to any one of (4) to (9), further including
a plurality of time digital converters and a plurality of the histogram generator arranged for each of the pixels,
in which each of the plurality of time digital converters generates a digital signal corresponding to a reception time of the two or more reflected light pulse signals received by a pixel corresponding, and
each of the plurality of the histogram generator generates the two or more histograms on the basis of the digital signal generated by the time digital converter corresponding.

(14) The photodetection device according to (13),
in which each of the plurality of pixels sequentially outputs two or more light reception signals according to the two or more reflected light pulse signals in one frame period, and the light reception signals output of the respective pixels are input to the plurality of time digital converters in parallel.

(15) The photodetection device according to any one of (10) to (14),
in which the time digital converter outputs a gray code corresponding to a light reception time, and
the histogram generator includes a conversion table for converting the gray code into light reception time data.

(16) The photodetection device according to any one of (3) to (15), further including
a storage section that stores the two or more duplicate histograms having a bin count corresponding to a least common multiple of the two or more time intervals.

(17) The photodetection device according to any one of (3) to (15), further including
a storage section having a storage capacity corresponding to a bin count of the histogram corresponding to a maximum time interval among the two or more time intervals.

(18) The photodetection device according to (17), further including:
a bin expanding section that stores the histogram corresponding to the maximum time interval in the storage section as one unit and expands the histogram corresponding to the two or more time intervals excluding the maximum time interval in the one unit and stores the histogram in the storage section;
a peak detecting section that repeats, for each of a plurality of the one unit, a process of detecting a place where light reception times of peaks of the two or more histograms match each other in a storage area of the storage section including the two or more histograms corresponding to the two or more time intervals in each one unit;
a maximum peak detecting section that detects a maximum value of the peak from among the plurality of the one unit;
a shift section that shifts the maximum value of the peak to a center in the storage area corresponding; and
a centroid calculation section that performs a centroid calculation in the storage area shifted by the shift section.

(19) The photodetection device according to any one of (3) to (18),
in which the histogram generator generates the two or more histograms on the basis of the two or more reflected light pulse signals repeatedly obtained when the light pulse signal is repeatedly caused to emit light at each of the two or more time intervals, and flattens a number of frequencies other than peaks of the two or more histograms by periodically shifting start times when the two or more histograms are generated.

(20) The photodetection device according to any one of (7) to (9), further including
an interference detecting section that detects presence or absence of interference by an unknown light pulse signal,
in which the ranging section measures the distance of the object on the basis of the reconstructed histogram in a case where the interference detecting section detects that there is no interference.

(21) The photodetection device according to (20), further including
a synchronization determination section that determines whether or not synchronization with cycle switching of the unknown light pulse signal is possible when the interference is detected by the interference detecting section,
in which the histogram generator generates the two or more histograms in synchronization with the unknown light pulse signal when the synchronization determination section determines that synchronization is possible.

(22) The photodetection device according to (21), further including
a cycle detecting section that detects a switching order of a cycle of the unknown light pulse signal,
in which the histogram generator generates the two or more histograms in a switching order in which the switching order of the cycle detected by the cycle detecting section is temporally shifted or in a switching order different from the switching order of the cycle detected by the cycle detecting section.

(23) The photodetection device according to (21) or (22), further including
a light emission timing control section that controls a light emission timing of a light pulse signal including the first light pulse signal and the second light pulse signal such that interference with the unknown light pulse signal is mitigated when the synchronization determination section determines that synchronization is impossible.

(24) The photodetection device according to (23),
in which the light emission timing control section randomizes light emission periods of two or more light pulse signals used to generate each of a plurality of histograms included in each of the two or more duplicate histograms.

(25) The photodetection device according to (24),
in which the light emission timing control section randomizes the light emission periods of the two or more light pulse signals such that a total number of light pulse signals used to generate the plurality of histograms is equal for each of the two or more duplicate histograms.

(26) A ranging system including:
a light emitting device; and the photodetection device according to any one of (3) to (25),
in which the light emitting device includes:
a first light emitting section that emits a plurality of the first light pulse signal at the first time interval; and
a second light emitting section that emits a plurality of the second light pulse signal at the second time interval, and
the photodetection device includes a light emission timing control section that controls the first light emitting section and the second light emitting section such that after the first light emitting section emits the first light pulse signal in a number corresponding to the first time range at the first time interval, the first light emitting section emits the second light pulse signal in a number corresponding to the second time range at the second time interval.

(27) The ranging system according to (26),
in which the light emitting device emits each of the two or more light pulse signals by a number corresponding to the time range corresponding at the two or more time intervals, and
the light emission timing control section performs control to sequentially emit the two or more light pulse signals.

(28) The ranging system according to (26) or (27),
in which the photodetection device includes an interference detecting section that detects an unknown light pulse signal, and
the light emission timing control section causes the light emitting device to repeatedly emit light in a sequence different from a sequence of the two or more time intervals at which the unknown light pulse signal detected by the interference detecting section is caused to emit light, or at a time interval different from the two or more time intervals.

(29) The ranging system according to (28),
in which the histogram generator generates the two or more histograms on the basis of the unknown light pulse signal in a state where the light emitting device does not emit light, and
the interference detecting section detects presence or absence of interference by the unknown light pulse signal on the basis of the two or more histograms.

(30) A ranging system including:
a light emitting device including
a first light emitting section that emits a plurality of first light pulse signals at a first time interval, and
a second light emitting section that emits a plurality of second light pulse signals at a second time interval;
a light receiving section that receives a first reflected light pulse signal in which the first light pulse signal is reflected by an object within a first time range, and receives a second reflected light pulse signal in which the second light pulse signal emitted at a second time interval different from the first time interval is reflected by the object within a second time range different from the first time range; and
a packet generator that generates ranging data having two or more histograms including a first histogram generated on the basis of the first reflected light pulse signal and a second histogram generated on the basis of the second reflected light pulse signal in units of frames,
in which the ranging data includes a start section, a plurality of packets, and an end section,
the start section includes an identifier indicating a head of a frame and a number of two or more time intervals including the first time interval and the second time interval,
the packet includes a header including a bin count of a histogram corresponding among the two or more histograms, histogram data constituting the histogram corresponding, and a footer including end information of the histogram corresponding, and
the end section includes an identifier indicating an end of the frame.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the contents defined in the claims and equivalents thereof.

### REFERENCE SIGNS LIST

1 Ranging system
2 Overall control section
3 Light emitting device
4, 4a, 4b, 4c, 4d Photodetection device
5, 5a AP
11 First light emitting section
12 Second light emitting section
21 Clock generation section
22 Control section
23 Light emission timing control section
24, 24a, 24b Drive circuit
25 Light receiving section
26 Ranging control section
27 Ranging processing section
28 Interface section
30 Pixel
41, 41a Time digital converter
42, 42a Histogram generator
44, 44a, 44b, 77 Ranging section
45 Duplicate histogram generator
50, 50a, 50b Pixel array section
51 First pixel group
52, 52a Second pixel group
61 Signal line
62 Column selection circuit
63 Column selection line
64 Row selection circuit
65 Row selection line
71 Bin expanding section
72 Peak detecting section
73 Maximum peak detecting section
74 Shift section
75 Centroid calculation section
76 Packet generation section
80, 90 Ranging data
81, 91 Start section
82, 82a, 82b, 82c, 82d, 82e, 82f, 82g, 92 Packet
83, 93 End section
84, 94 Header
85, 85a, 85b, 95 Histogram data
86, 96 Footer
87, 97a, 97b, 97c, 97d Histogram
88 Padding section
101 Gray code counter
102 Latch section
103 GT conversion section
104 Bin counter
105 Photoelectric conversion element
111 Minimum search section
112 Weighting section
113, 114 Memory section
120 Interference suppression section
121 Interference detecting section
122 Synchronization determination section
123 Cycle detecting section

1. A photodetection device comprising:
a light receiving section that receives, within a first time range, a first reflected light pulse signal in which a first light pulse signal emitted at a first time interval is reflected by an object, and receives, within a second time range different from the first time range, a second reflected light pulse signal in which a second light pulse signal emitted at a second time interval different from the first time interval is reflected by the object; and
a histogram generator that generates a first histogram in which a light reception frequency of the first reflected light pulse signal received within the first time range is classified for each predetermined fixed unit period, and generates a second histogram in which a light reception frequency of the second reflected light pulse signal received within the second time range is classified for each unit period.

2. The photodetection device according to claim 1, further comprising
a duplicate histogram generator that generates a first duplicate histogram obtained by duplicating the first histogram by a first number corresponding to the first time interval and generates a second duplicate histogram obtained by duplicating the second histogram by a second number corresponding to the second time interval.

3. The photodetection device according to claim 2,
wherein the light receiving section receives, within two or more different time ranges, two or more reflected light pulse signals in which two or more light pulse signals emitted at two or more time intervals including the first time interval and the second time interval different from each other are reflected by the object,
the histogram generator generates two or more histograms obtained by classifying light reception frequencies of the two or more reflected light pulse signals received within the two or more time ranges for each unit period,
the duplicate histogram generator generates two or more duplicate histograms obtained by duplicating each of the two or more histograms by a number corresponding to the time intervals corresponding,
the two or more histograms generated by the histogram generator include the first histogram and the second histogram, and
the two or more duplicate histograms generated by the duplicate histogram generator include the first duplicate histogram and the second duplicate histogram.

4. The photodetection device according to claim 3,
wherein the light receiving section includes a plurality of pixels arranged in two or more in each of a first direction and a second direction, and
each of the plurality of pixels receives the two or more reflected light pulse signals within the two or more time ranges.

5. The photodetection device according to claim 4, further comprising
a packet generator that generates ranging data including the two or more histograms in units of frames,
wherein the ranging data includes a start section, a plurality of packets, and an end section,
the start section includes an identifier indicating a head of a frame and a number of the two or more time intervals,
the packet includes a header including a bin count of a histogram corresponding and a number of the plurality of pixels in the two or more histograms, histogram data constituting the histogram corresponding, and a footer including end information of the histogram corresponding, and
the end section includes an identifier indicating an end of the frame.

6. The photodetection device according to claim 4, further comprising
a packet generator that generates ranging data including the two or more histograms in units of frames,
wherein the ranging data includes a start section, a plurality of packets, and an end section,
the start section includes an identifier indicating a head of a frame, a number of the plurality of pixels, and a number of the two or more time intervals,
the packet includes a header including information indicating a pixel position, histogram data constituting the histogram corresponding among the two or more histograms, and a footer including end information of the histogram corresponding, and
the end section includes an identifier indicating an end of the frame.

7. The photodetection device according to claim 4, further comprising
a ranging section that measures a distance of the object on a basis of a light reception time in a case where light reception times corresponding to peak positions of the two or more duplicate histograms including the first duplicate histogram and the second duplicate histogram match each other or a light reception time corresponding to a maximum peak position of a reconstructed histogram synthesized by aligning bin counts of the two or more duplicate histograms.

8. The photodetection device according to claim 7,
wherein the ranging section adds the two or more duplicate histograms for each bin to generate the reconstructed histogram.

9. The photodetection device according to claim 7,
wherein each of the two or more duplicate histograms has same bin count, and
the ranging section searches for a same bin in which each of the two or more duplicate histograms has a peak value of a light reception frequency, and generates the reconstructed histogram on a basis of a minimum peak value in the bin searched.

10. The photodetection device according to claim 4, further comprising
a plurality of time digital converters and a plurality of the histogram generator arranged for each first pixel group including two or more of the pixels arranged in the first direction,
wherein each of the plurality of time digital converters sequentially generates a digital signal according to a reception time of the two or more reflected light pulse signals received by each pixel in the first pixel group corresponding, and
each of the plurality of the histogram generator generates the two or more histograms on a basis of the digital signal sequentially generated by the time digital converter corresponding.

11. The photodetection device according to claim 10,
wherein a plurality of second pixel groups each including two or more of the pixels arranged in the second direction is arranged in the first direction, and
the plurality of the second pixel groups is sequentially selected, and each pixel in the second pixel group selected inputs light reception signals corresponding to the two or more reflected light pulse signals to the plurality of time digital converters in parallel.

12. The photodetection device according to claim 11,
wherein each pixel in the second pixel group selected sequentially outputs two or more light reception signals according to the two or more reflected light pulse signals in one frame period, and the light reception signals output of the respective pixels in the second pixel group are input to the plurality of time digital converters in parallel.

13. The photodetection device according to claim 4, further comprising
a plurality of time digital converters and a plurality of the histogram generator arranged for each of the pixels,
wherein each of the plurality of time digital converters generates a digital signal corresponding to a reception time of the two or more reflected light pulse signals received by a pixel corresponding, and
each of the plurality of the histogram generator generates the two or more histograms on a basis of the digital signal generated by the time digital converter corresponding.

14. The photodetection device according to claim 13,
wherein each of the plurality of pixels sequentially outputs two or more light reception signals according to the two or more reflected light pulse signals in one frame period, and the light reception signals output of the respective pixels are input to the plurality of time digital converters in parallel.

15. The photodetection device according to claim 10,
wherein the time digital converter outputs a gray code corresponding to a light reception time, and
the histogram generator includes a conversion table for converting the gray code into light reception time data.

16. The photodetection device according to claim 3, further comprising
a storage section that stores the two or more duplicate histograms having a bin count corresponding to a least common multiple of the two or more time intervals.

17. The photodetection device according to claim 3, further comprising
a storage section having a storage capacity corresponding to a bin count of the histogram corresponding to a maximum time interval among the two or more time intervals.

18. The photodetection device according to claim 17, further comprising:
a bin expanding section that stores the histogram corresponding to the maximum time interval in the storage section as one unit and expands the histogram corresponding to the two or more time intervals excluding the maximum time interval in the one unit and stores the histogram in the storage section;
a peak detecting section that repeats, for each of a plurality of the one unit, a process of detecting a place where light reception times of peaks of the two or more histograms match each other in a storage area of the storage section including the two or more histograms corresponding to the two or more time intervals in each one unit;
a maximum peak detecting section that detects a maximum value of the peak from among the plurality of the one unit;
a shift section that shifts the maximum value of the peak to a center in the storage area corresponding; and
a centroid calculation section that performs a centroid calculation in the storage area shifted by the shift section.

19. The photodetection device according to claim 3,
wherein the histogram generator generates the two or more histograms on a basis of the two or more reflected light pulse signals repeatedly obtained when the light pulse signal is repeatedly caused to emit light at each of the two or more time intervals, and flattens a number of frequencies other than peaks of the two or more histograms by periodically shifting start times when the two or more histograms are generated.

20. The photodetection device according to claim 7, further comprising
an interference detecting section that detects presence or absence of interference by an unknown light pulse signal,
wherein the ranging section measures the distance of the object on a basis of the reconstructed histogram in a case where the interference detecting section detects that there is no interference.

21. The photodetection device according to claim 20, further comprising
a synchronization determination section that determines whether or not synchronization with cycle switching of the unknown light pulse signal is possible when the interference is detected by the interference detecting section,
wherein the histogram generator generates the two or more histograms in synchronization with the unknown light pulse signal when the synchronization determination section determines that synchronization is possible.

22. The photodetection device according to claim 21, further comprising
a cycle detecting section that detects a switching order of a cycle of the unknown light pulse signal,
wherein the histogram generator generates the two or more histograms in a switching order in which the switching order of the cycle detected by the cycle detecting section is temporally shifted or in a switching order different from the switching order of the cycle detected by the cycle detecting section.

23. The photodetection device according to claim 21, further comprising
a light emission timing control section that controls a light emission timing of a light pulse signal including the first light pulse signal and the second light pulse signal such that interference with the unknown light pulse signal is mitigated when the synchronization determination section determines that synchronization is impossible.

24. The photodetection device according to claim 23,
wherein the light emission timing control section randomizes light emission periods of two or more light pulse signals used to generate each of a plurality of histograms included in each of the two or more duplicate histograms.

25. The photodetection device according to claim 24,
wherein the light emission timing control section randomizes the light emission periods of the two or more light pulse signals such that a total number of light pulse signals used to generate the plurality of histograms is equal for each of the two or more duplicate histograms.

26. A ranging system comprising:
a light emitting device; and
the photodetection device according to claim 3,
wherein the light emitting device includes:
a first light emitting section that emits a plurality of the first light pulse signal at the first time interval; and
a second light emitting section that emits a plurality of the second light pulse signal at the second time interval, and
the photodetection device includes a light emission timing control section that controls the first light emitting section and the second light emitting section such that after the first light emitting section emits the first light pulse signal in a number corresponding to the first time range at the first time interval, the first light emitting section emits the second light pulse signal in a number corresponding to the second time range at the second time interval.

27. The ranging system according to claim 26,
wherein the light emitting device emits each of the two or more light pulse signals by a number corresponding to the time range corresponding at the two or more time intervals, and
the light emission timing control section performs control to sequentially emit the two or more light pulse signals.

28. The ranging system according to claim 26,
wherein the photodetection device includes an interference detecting section that detects an unknown light pulse signal, and
the light emission timing control section causes the light emitting device to repeatedly emit light in a sequence different from a sequence of the two or more time intervals at which the unknown light pulse signal detected by the interference detecting section is caused to emit light, or at a time interval different from the two or more time intervals.

29. The ranging system according to claim 28,
wherein the histogram generator generates the two or more histograms on a basis of the unknown light pulse signal in a state where the light emitting device does not emit light, and
the interference detecting section detects presence or absence of interference by the unknown light pulse signal on a basis of the two or more histograms.

30. A ranging system comprising:
a light emitting device including
a first light emitting section that emits a plurality of first light pulse signals at a first time interval, and
a second light emitting section that emits a plurality of second light pulse signals at a second time interval;
a light receiving section that receives a first reflected light pulse signal in which the first light pulse signal is reflected by an object within a first time range, and receives a second reflected light pulse signal in which the second light pulse signal emitted at a second time interval different from the first time interval is reflected by the object within a second time range different from the first time range; and
a packet generator that generates ranging data having two or more histograms including a first histogram generated on a basis of the first reflected light pulse signal and a second histogram generated on a basis of the second reflected light pulse signal in units of frames,
wherein the ranging data includes a start section, a plurality of packets, and an end section,
the start section includes an identifier indicating a head of a frame and a number of two or more time intervals including the first time interval and the second time interval,
the packet includes a header including a bin count of a histogram corresponding among the two or more histograms, histogram data constituting the histogram corresponding, and a footer including end information of the histogram corresponding, and
the end section includes an identifier indicating an end of the frame.
